(19) United States
(12) Patent Application Publication
(10) Pub. No.: US 2026/0278339 A1
(43) Pub. Date: Sep. 17, 2026

(54) MODELED CONVERSIONS FOR A CONNECTION NETWORK SYSTEM

(71) Applicant: Microsoft Technology Licensing, LLC, Redmond, WA (US)

(72) Inventors: Aman Gupta, San Jose, CA (US); John Bencina, Pinole, CA (US); Yajun Wang, Sunnyvale, CA (US); Qingquan Song, Sunnyvale, CA (US); Shao Tang, Cupertino, CA (US); Li Kan, Santa Clara, CA (US)

(73) Assignee: Microsoft Technology Licensing, LLC, Redmond, WA (US)

(21) Appl. No.: 19/079,629

(22) Filed: Mar. 14, 2025

(51) Int. Cl. G06N 3/0455; G06N 3/0475

(52) U.S. Cl. CPC G06N 3/0455; G06N 3/0475

(57) ABSTRACT

Modeled conversions for connection networking are described. A method comprises generating a first input vector comprising a set of sequence features for a group of entities using a transformer layer of a machine learning model, generating a second input vector comprising a set of identity profile features for the group of entities using a generative artificial intelligence layer, receiving a third input vector comprising a set of conversion features, concatenating the first input vector, the second input vector, and the third input vector into a concatenated vector, normalizing the concatenated vector to form a normalized vector, projecting the normalized vector to form a projected vector, and generating a first metric based on the projected vector using a multi-gate mixture-of-experts (MMOE) layer of the ML model, the first metric comprising a value indicating whether there is a deterministic entity level conversion event for a group level conversion event.

### BACKGROUND

Software applications harness the power of computer networks to distribute a wide variety of digital content to user computing devices. To assess the effectiveness of these content distribution systems, developers rely on “signals” generated at the recipient devices. These signals comprise measurable user interactions, including clicks, conversions, session durations, and a range of other user interface events. By analyzing these interactions, the reach and impact of a particular content delivery mechanism or ranking algorithm can be determined. The signals reveal whether the right audience is being targeted and engaged, and to what extent they respond to the distributed content. This feedback loop not only helps quantify performance but also guides the iterative refinement of ranking models, content personalization strategies, and overall user experience. Over time, the insights gleaned from these signals become invaluable for optimizing content distribution campaigns, ensuring that they are more closely aligned with evolving user preferences and behaviors.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates a system in accordance with one embodiment.

FIG. 3 illustrates a content delivery system in accordance with one embodiment.

FIG. 4 illustrates a logic diagram in accordance with one embodiment.

FIG. 5 illustrates a logic diagram in accordance with one embodiment.

FIG. 6 illustrates a logic diagram in accordance with one embodiment.

FIG. 7 illustrates a machine learning (ML) architecture in accordance with one embodiment.

FIG. 8 illustrates a transformer model in accordance with one embodiment.

FIG. 9 illustrates a logic flow in accordance with one embodiment.

FIG. 10 illustrates a logic flow in accordance with one embodiment.

FIG. 11 illustrates an apparatus in accordance with one embodiment.

FIG. 12 illustrates a logic diagram in accordance with one embodiment.

FIG. 13 illustrates an artificial neural network (ANN) in accordance with one embodiment.

FIG. 14 illustrates a computer-readable storage medium in accordance with one embodiment.

FIG. 15 illustrates a computing architecture in accordance with one embodiment.

FIG. 16 illustrates a communications architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. For example, embodiments of the present disclosure comprise a content delivery system implementing various ML models to generate modeled metrics for member-level conversion events using cohort-level data. Further, the content delivery system ensures privacy compliance, addresses cross-device conversion tracking, adjusts for inflated conversion counts, and integrates various conversion data types, all while maintaining accuracy in conversion modeling. The content delivery system estimates member-attributed conversion events by using only privacy-safe cohort-based tracking data, thereby reducing or eliminating reliance on member-level tracking. As a result, the estimated member-attributed conversion events may be used for various downstream tasks, such as measuring credit specific outcomes of a content delivery campaign managed by a content delivery system. Although exemplary embodiments are described in connection with a particular AI system or an ML model, the principles described herein can also be applied to other types of AI systems and ML models as well. Embodiments are not limited in this context.

### Overview

A connection network system is an online platform for professionals that fosters business connections, supports career advancement, and facilitates industry-specific collaborations. A connection network system is a membership-based service that caters to professionals, job seekers, recruiters, and companies of all sizes. Users can create in-depth profiles highlighting their work experience, education, skills, endorsements, and achievements, enabling them to network strategically, join interest-based groups, and stay informed on industry trends. In addition to its powerful networking capabilities, a connection network system integrates features that assist with job discovery, enabling individuals to receive personalized job recommendations, apply directly through the platform, and engage with potential employers. Companies leverage network services for talent acquisition, employer branding, company updates, and thought leadership activities, making it a central hub for building a professional presence. Furthermore, a connection network system offers an extensive catalog of courses to help users develop new skills, enhance their resumes, and reach their career goals, while the platform's publishing tools allow members to share original articles, insights, and multimedia content that can increase visibility and credibility. Together, these robust features create an indispensable resource for professionals seeking meaningful connections, professional growth, and valuable business opportunities across a wide array of industries.

A connection network system may provide access to a large amount of electronic content aimed at professional networking and career development. For example, a connection network system may list employment opportunities posted by employers across different industries, professional profiles with detailed information about entities of the connection network system (e.g., work experience, skills, and endorsements), articles or posts created by entities and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where entities can share ideas and discuss industry trends, and other types of content designed to facilitate professional growth and industry engagement.

Various types of entities may generate, modify, store, read, or otherwise interact with the electronic content of the connection network system. Non-limiting examples of entities include an individual, a person, an entity, a member, a subscriber, a corporate entity, a company, a business, an organization, a governmental agency, a community, a group, and the like. In some cases, the connection network system collects a variety of data associated with the various types of entities of the platform in accordance with privacy policies which govern how this information is collected, used, and shared. For an entity such as a user or member of the connection network system, the entity data may include basic profile information such as name, job title, industry, location, educational background, demographic information, work history, and so forth. For an entity such as a company, the entity data may also include basic profile information such as a company name, description, industry, business segment, jobs, careers, offices, geographic locations, and so forth. Additionally, the connection network system may collect activity data for entities representing various interactions and behaviors exhibited while on the platform. Examples of activity data including interactions between entities or interacting with electronic content of the connection network system, including profile updates, content engagement, search and navigation behavior, job activities, networking activities, group participation, skill endorsements and recommendations, advertisement engagement, learning activities, event participation, followers activities, interactions with external content, engagement patterns, behavioral trends, organic contents, sponsored contents, sales activities, marketing activities, conversion events, and so forth.

In some cases, a connection network system may enhance network services offered by the connection network system based on the entity data and activity data of its entities. Examples of network services include messaging services, search services, ranking services, recommendation services, advertising services, content delivery services, and so forth. For example, a connection network system may use activity data to personalize entity experiences, optimize content displayed in content feeds, improve targeted advertising, and enhance platform features. It also plays a role in developing analytics and reporting tools, helping entities and businesses understand their network reach, content effectiveness, and engagement with their audience.

Tracking entities and entity activity data, however, remains a technically difficult problem. For example, a tracking system for a connection network system may attempt to track an entity accessing a third-party system. In such cases, the third-party system may be unaware of the entity identity or sending entity information that is insufficient to deterministically determine an entity identity. In the former case, the third-party system may be unable to collect any personal identifying information (PII) for a visiting entity, such as when the visiting entity anonymously browses a website. In the latter case, data privacy policies may prohibit the collection or release of any PII for a visiting entity to maintain confidentiality, and therefore the third-party system may send non-deterministic data (e.g., a network address). In either case, the tracking system for the connection network system does not have access to entity data or entity activity data when visiting the third-party system. As a result, the connection network system may be unaware of conversion events that occur on the third-party system, sometimes referred to as “an offsite conversion event.” A conversion event is when an entity performs a specific task or reaches a defined objective. An example of a conversion event is when a user purchases a product or service of a company attributed to a digital advertisement of a content delivery campaign executed by the connection network system. Other examples of conversion events may include impressions, clicks, customer relationship management (CRM) opportunities, and other metrics for a defined objective.

The entity data and entity activity data may be particularly important for a network service such as a content delivery service designed to deliver different types of content items to an audience of entities. A connection network system may offer a content delivery system that delivers electronic content items to various entities based on a number of different factors. For example, the content delivery system may interleave different types of content items for presentation in a content feed of an entity. The content feed is a prominent content area on a webpage (e.g., a homepage) of a website where an entity may view a personalized stream of posts, updates, articles, and activities. It compiles content from network connections, companies followed, and topics of interest to keep informed about professional news, industry trends, job opportunities, and other relevant information for career development. An entity may interact with the content items presented in the content feed by liking, commenting on, and sharing posts, as well as following hashtags to tailor the content to specific interests. The content feed serves as a central hub for networking, learning, and staying updated within a professional community, all personalized through algorithms based on connections and engagement history.

The content feed may comprise a portion of a web section that displays a mixture of different types of content items, such as organic items generally referred to as organic content (OC) and sponsored items generally referred to as sponsored content (SC), for example. OC refers to digital content items that entities share with each other in a connection network system without payment. Non-limiting examples of OC include articles, shares, likes, and so forth. SC refers to digital content items that entities share in a connection network system with payment. Non-limiting examples of SC include digital advertisements, marketing collateral, and so forth. A digital content item may comprise multimedia information of different modalities, such as text, video, graphics, images, audio, animations, or any combination of the foregoing.

A content delivery system uses a blending algorithm that assigns, allocates, or loads OC and SC to content slots in the content feed. A content slot (or simply a slot) is a section of the content feed of some defined dimension and geometry designed to display a given content item to the entity. The section may be rendered to an entity or non-rendered to the entity. The content delivery system may select the different types of content items for different slots of the content feed based on a combination of the entity data, activity data, and/or objectives associated with the entity in order to personalize the content feed. For example, the blending algorithm may select an OC for a first slot of the content feed to increase an engagement metric for the entity, such as a number of likes, comments, or shares. The blending algorithm may select a SC for a second slot of the content feed to increase a revenue metric for the entity. As the entity scrolls through the content feed the blending algorithm assigns more content items to more slots in a seamless and continuous manner. During this process, the blending algorithm attempts to blend the OC and SC in the content feed to achieve one or more defined objectives. The result of this process is a content feed that interleaves the OC and SC in a continuous manner while optimizing for multiple objectives.

The content delivery system uses entity data and entity activity data to track a metric associated with an entity for SC, sometimes referred to as “credit attribution” or simply “attribution.” An example metric is a revenue metric. The revenue metric may be based, at least in part, on conversion events attributed to a specific user or member, sometimes referred to as “member-attributed conversion events.” For example, when an entity, such as a user, navigates to the web section to start a browsing session, the content delivery system detects the start of the session and begins generation of the content feed. The content delivery system uses entity data and entity activity data associated with the user to select OC and SC relevant to the user, and the blending algorithm assigns the OC and SC to content slots in the content feed to achieve a defined objective, such as maximizing short-term or long-term revenue associated with the user. Missing or inaccurate entity data and/or entity activity data, such as from third-party systems, makes it difficult for the system to accurately calculate member-attributed conversion events, which in turn decreases revenue associated with OC and SC, interrupts interaction between content items and users, and degrades overall user experience.

Embodiments solve these and other technical challenges. Embodiments are generally directed to a connection network system. Some embodiments are particularly directed to artificial intelligence (AI) and machine learning (ML) techniques to support applications and/or services provided by a connection network system. For example, embodiments of the present disclosure comprise a content delivery system implementing one or more ML models to generate modeled metrics for member-attributed conversion events using privacy-safe or privacy-constrained tracking data. In some embodiments, for example, an ML model may use group-level data or “cohort-level data” to estimate member-level data. A group comprises a set of N entities, where N represents any positive integer greater than 2. For example, assume an entity is an individual user while a group may comprise N number of individual users. In some cases, a group is given a group name to represent an attribute, characteristic, or trait of the individual users. Further, the content delivery system ensures privacy compliance, addresses cross-device conversion tracking, adjusts for inflated conversion counts, and integrates various conversion data types, all while maintaining accuracy in conversion modeling. The content delivery system estimates member-attributed conversion events by using only privacy-safe cohort-based tracking data, thereby reducing or eliminating reliance on member-level tracking. This leads to a more accurate estimate of member-attributed conversion events relative to conventional techniques that may be used for various downstream tasks, such as measuring credit specific outcomes of a content delivery campaign managed by a campaign manager of a content delivery system.

In the absence of reliable member-level data, particularly for offsite conversion events, the content delivery system uses group-level data to infer a number of member-attributed conversion events. However, the use of group-level data leads to an inflated number of member-attributed conversion events due to a number of inflation factors. For example, inflation is correlated to group size since additional members introduce more chances for conversion events. In another example, the use of k anonymous group identities leads to significant record information, overstating true conversion counts by a factor of 3× to 8×.

This technical problem is further exacerbated by privacy changes around the use of third party cookies and tracking have significantly degraded the ability to map some third-party conversion events back to individuals in a deterministic manner. On-Device Attribution (ODA) potentially solves for this issue on the same device, however cross device attributions are still affected. Group-level attribution strategies also suffer from inflation of conversion counts caused by the non-deterministic relationship between conversions and engagements due to the loss of member identifiers. The loss of deterministic attribution negatively affects reporting and optimization features of the content delivery system. Reporting is impacted because the content delivery system is unable to provide a definitive view of conversion activity both internally and externally. This uncertainty can lead to the overcounting of non-qualified conversion events. Optimization is impacted because the content delivery system does not have ground truth labels used to train predictive models like predicted conversion rate (pCVR).

Modeled conversions need to accurately recover the “ground-truth” offsite conversion counts given the inflated group counts. This inflation occurs because conversions and engagements are pooled at the group level. Inflation is correlated to group size since additional members introduce more chances of engagements and conversion events appearing. Therefore, a technical solution is needed to solve this technical problem for cross-device conversions. This includes engagements which occur on a client device using an application for the connection network system, as well as offsite conversion events that occur on other devices.

Current success metrics indicate a growing number of errors in aggregated conversion counts when comparing predicted conversions against the known member ground-truth. In massive web-scale online production systems, this error rate will lead to an eventual loss of ground truth data and instead will need to benchmark against a suitable proxy measure. Measuring error rates at an individual campaign level is challenging at low volumes due to inherent noise. Even minor deviations can represent large percentage changes.

Embodiments solve this technical problem using a ML model to predict a metric such as an inflation value representing an inflation quantity of group-level conversion inflation and/or a deflation value representing a deflation quantity to deflate group-level conversion inflation of member-attributed conversion events. The predicted metric is applied to a reported group conversion number to obtain more accurate prediction counts. For example, the ML model deflates a number of member-attributed conversion events estimated using group-level data to obtain a more accurate number of member-attributed conversion events.

In various embodiments, the content delivery system uses a model-based approach to solve the technical problem of group-level conversion inflation. The content delivery system implements an ML model to estimate member-attributed cross-device conversions using only privacy-constrained tracking data based on a fuzzy identity. This can mitigate privacy issues by using group identity and address signal loss due to the deprecation of third-party cookies through a member identity graph. It handles outcome attribution where the exact member identity is unavailable.

Further, the content delivery system uses the ML model to perform sequential-based prediction at an event level. In some embodiments, for example, the content delivery system links group-based attribution results back to corresponding member-based attribution at the conversion event level. When attributing at the group level, there could be three types of attributed results compared to a member level. In a first scenario, both member and group conversion are attributable. The group and member engagement attribution are the same. In this case, the group-attributed conversion is not inflated. In a second scenario, both member and group conversion are attributable. The group and member engagement attributions are different. In this case, the group-attributed conversion is not inflated, but the attributed engagement is misleading. In a third scenario, the group conversion is attributable and the member conversion is not attributable. In this case, the group-attributed conversion is inflated.

A training component for the content delivery system generates a training dataset to train the ML model. At a high level, the training component anonymizes member engagement and member external conversion events and performs group-based last-touch attribution. Group-based attributed events are labeled with member-based deterministic attribution results with corresponding member-based attributed conversion counts. Specifically, in a first step, the training component conducts group conversion attribution with any touch method. To differentiate the above-mentioned scenarios I and II, the training component first conducts any touch conversion attribution method for group-based attribution. The training component associates the per-group conversion with all group engagement footprints (within a producing entity conversion window). In addition, the training component labels if the group engagement footprint is last-touch or not. In a second step, the training component performs matching with both conversion and engagement events attribution. The training component compares all group engagement footprints with member last-touch attribution results. If there is a group any-touch result that matches a member last-touch, but it is not a group last-touch, then the training component labels the group-based conversion as scenario II. If there are group last-touch results matching member last-touch results, then the training component labels them as scenario I. If there is not any member last-touch result matching a group any-touch attribution, the training component labels it as an inflated conversion, namely scenario III.

Once the ML model is trained, the trained ML model is deployed to a production server for the content delivery system for inferencing operations for a massive web-scale online system, such as a connection network system. The model task for the ML model is to predict the probability of the existence of deterministic member-based conversion event for each cohort-based conversion event. In some embodiments, for example, the target variable for the ML model is a binary variable, such as a 1 or 0. For each cohort-based conversion event whether there is an underlying deterministic member-based conversion event, the target variable is assigned a value of 1 for having member-based conversion event and a value of 0 for none.

In various embodiments, the ML model may be implemented as a deep learning model. In some embodiments, for example, the ML model is a sequential-based model using a transformer and one or more multi-gate mixture-of-experts (MMOE) model to jointly predict inflation for multiple metrics reported to a campaign manager. The ML model predicts whether a given group-level attributed conversion is inflated as compared to the member-level attributed conversion. The MMOE with multi-transformer architecture is designed for joint inflation predictions across multiple conversion outcomes, such as web conversions, LGF, and qualified leads, and other outcomes. The gate weights are learned during the model training phase. During inference, these weights are dynamically computed based on the model input, making them sample-dependent rather than manually fixed. Leveraging a large language model (LLM) encoder, the ML model takes member profiles belonging to the probabilistic identity (e.g., a private group) or the exact identity and extracting the corresponding embedding for the members belonging to the group via the mean pool, concatenation, or element-wise Hadamard product. Transformer output compression is implemented for efficient training and inference.

Embodiments provide several technical solutions to multiple technical problems. For example, embodiments implement a model-based approach to solve the technical problem of group-level conversion inflation. Group-level conversion inflation artificially increases a number of member-attributed conversion events, thereby leading to inaccurate downstream tasks such as credit allocation. The content delivery system implements an ML model to estimate member-attributed cross-device conversions using only privacy-constrained tracking data based on a fuzzy identity. This can mitigate privacy issues by using group identity and address signal loss due to the deprecation of third-party cookies through a member identity graph. It handles outcome attribution where the exact member identity is unavailable, such as during offsite conversion events. In addition, embodiments implement an ML model using a MMOE structure for modeled attribution at an event level that accommodates multiple outcomes and varying number of experts to meet future system needs. The MMOE jointly predicts inflation for multiple metrics reported to other components of a content delivery system, such as a campaign manager to manage a content delivery campaign on behalf of a producing entity (e.g., an advertising company, a marketing company, etc.). Further, the MMOE is more accurate and efficient than other types of ML models, such as recurrent neural network (RNN) structures, for example. Other technical advantages exist as well.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### Detailed Embodiments

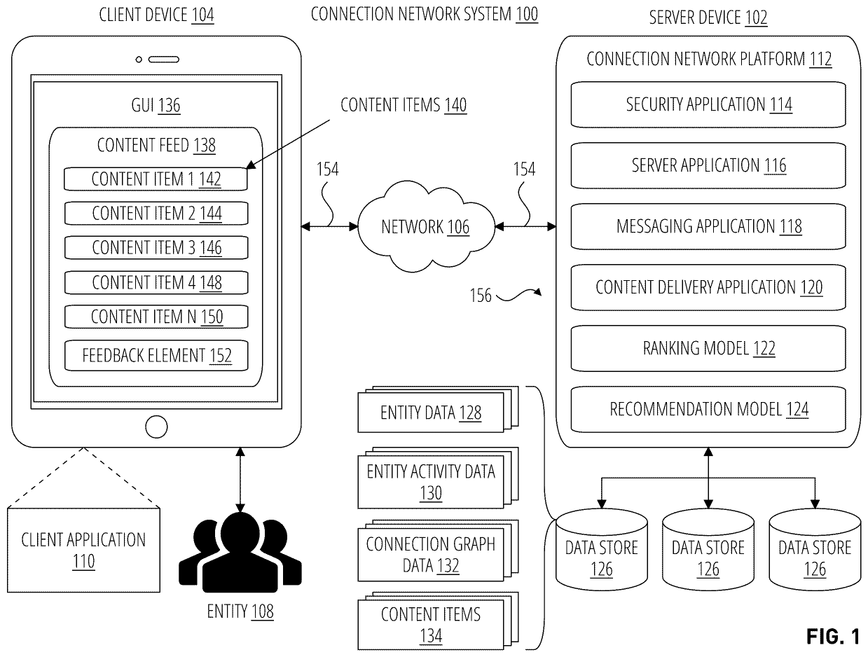

FIG. 1 illustrates a connection network system 100. The connection network system 100 is an example of an architecture or framework for an online computer and communications system designed to serve content items to an electronic device associated with a user. Embodiments are not limited to this example.

In general, the connection network system 100 may include a variety of servers, sub-systems, programs, modules, logs, and data stores. In particular embodiments, the connection network system 100 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 100 may also include suitable components such as network interfaces, security mechanisms, load balancers, failover servers, management-and-network-operations consoles, privacy software, and other suitable components, or any suitable combination thereof.

As depicted in FIG. 1, the connection network system 100 comprises a server device 102 communicating with a client device 104 over a network 106. Additionally, or alternatively, the client device 104 may communicate with another client device 104 in a peer-to-peer (P2P) mode or via the server device 102. In operation, an entity 108 interacts with a client application 110 of the client device 104 to access applications and services provided by a connection network platform 112 of the server device 102. The connection network platform 112 offers a number of network services 156 for the connection network system 100, such as network services provided by a security application 114, a server application 116, a messaging application 118, a content delivery application 120, a ranking model 122, and/or a recommendation model 124. The server device 102 has access to one or more data stores 126. The data stores 126 store information for the connection network platform 112, such as entity data 128, entity activity data 130, connection graph data 132, and content items 134.

The connection network system 100 comprises a server device 102. In particular embodiments, a server device 102 may be an electronic device including hardware, software, or embedded logic components or a combination of two or more such components and capable of carrying out the appropriate functionalities implemented or supported by a server device 102. The server device 102 may comprise a unitary server or a distributed server spanning multiple computers or multiple data centers. The server device 102 may comprise one or more physical servers or virtual servers hosting one or more networking applications. As an example and not by way of limitation, a server device 102 may comprise part of a larger server system comprising multiple server devices organized as a data center, an edge computing center, or a cloud-computing center. This disclosure contemplates any suitable server device 102. A server device 102 may be accessed by a network entity 108 at a client device 104 via the network 106. A client device 104 may enable its entity 108 to communicate with other entities 108 at the server device 102, such as via messaging applications 118.

In one embodiment, for example, the server device 102 may be implemented as a web server. The web server may be used for linking the connection network platform 112 to one or more of the client devices 104 via a network 106. The web server may include a mail server or other messaging functionality for receiving and routing messages between the connection network platform 112 and one or more client devices 104. An API-request server may allow a gaming platform, a third-party system, a messaging system, and/or an AI system to access information from the connection network platform 112 by calling one or more APIs. An action logger may be used to receive communications from a web server about a user's actions on or off the connection network platform 112. In conjunction with the action log, a third-party-content-object log may be maintained of user exposures to third-party-content objects. A notification controller may provide information regarding content objects to a client device 104. Information may be pushed to a client device 104 as notifications, or information may be pulled from a client device 104 responsive to a request received from a client device 104. Authorization servers may be used to enforce one or more privacy settings of the users of the connections networking system. A privacy setting of a user determines how particular information associated with a user can be shared. The authorization server may allow users to opt in to or opt out of having their actions logged by the connection network platform 112 or shared with other systems (e.g., a third-party system), such as, for example, by setting appropriate privacy settings. Third-party-content-object stores may be used to store content objects received from third parties, such as a third-party system. Location stores may be used for storing location information received from client device 104 associated with users. Advertisement-pricing modules may combine connections information, the current time, location information, or other suitable information to provide relevant advertisements, in the form of notifications, to a user.

The connection network system 100 comprises a connection network platform 112. In particular embodiments, the connection network platform 112 may be part of a network-addressable computing system that can host an online connection network. The connection network platform 112 may generate, store, receive, and send connection networking data, such as, for example, entity data 128 (e.g., user-profile data, concept-profile data, etc.), entity activity data 130 (e.g., user interactions with connection network platform 112), connection graph data 132 (e.g., connections between users or entities), content items 134, or other suitable data related to the online connection network. The connection network platform 112 may be accessed by the other components of the connection network system 100 either directly or via a network 106. As an example and not by way of limitation, a client device 104 may access the connection network platform 112 using the client application 110, which may be a web browser or a native application associated with the connection network platform 112 (e.g., a mobile connection network application, another suitable application, or any combination thereof) either directly or via a network 106.

The connection network platform 112 comprises a security application 114. In particular embodiments, a security application 114 may be an application or electronic device including hardware, software, or embedded logic components or a combination of two or more such components and capable of carrying out the appropriate functionalities implemented or supported by the security application 114. The security application 114 is a network security system that encompasses a suite of technologies, policies, and practices designed to protect the integrity, confidentiality, and availability of data within the connection network platform 112 from unauthorized access, attacks, and other security threats. The security application 114 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 114 implements security practices to ensure a robust defense against a wide array of cyber threats, safeguarding organizational assets and maintaining trust with stakeholders.

The connection network platform 112 comprises a server application 116. In particular embodiments, the server application 116 may be a web server to serve content information, such as content items 134, to the client application 110 of the client device 104. The server device 102 may accept an HTTP request and communicate to a client device 104 one or more HTML files responsive to the HTTP request. The server device 102 may send HTML files representing a webpage with content information for presentation via an electronic display of the client device 104 to the entity 108.

In particular embodiments, the server application 116 may be an application operable to provide various computing functionalities, services, and/or resources, and to send data to and receive data from the other entities of the network 106, such as the client device 104, the connection network platform 112, a third-party server, and other electronic devices within the connection network system 100. For example, the server application 116 may be an e-commerce application, a content application, an advertisement application, a web interface, a messaging application, a video application, a webpage, and so forth.

In particular embodiments, the server application 116 may be an application for managing various applications and services provided by the online connection network hosted on the connection network platform 112. In particular embodiments, the server application 116 may include hardware, software, or embedded logic components or a combination of two or more such components for carrying out the appropriate functionalities implemented or supported by connection network platform 112. Although the server device 102 is shown with a single server application 116, it should be noted that this is not by any way limiting and this disclosure contemplates any number of server applications 116.

The connection network platform 112 comprises a messaging application 118. The messaging application 118 is software that enables users to send and receive messages, including text, images, videos, and other multimedia content, over a network 106, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 112 comprises a content delivery application 120. The content delivery application 120 is a software tool that allows users to efficiently deliver content items to other users of the connection network platform 112 of the connection network system 100, such as content items 134 stored by one or more data stores 126 or third-party content servers. An example for the content delivery application 120 is a demand-side platform (DSP) used by users such as employees (e.g., an account manager) for an advertising entity. A DSP allows advertisers to purchase and manage ad inventory from multiple ad exchanges and networks through a single interface to implement marketing solutions for products or services of the advertiser. The content delivery application 120 allows advertisers to create, manage, and analyze their ad campaigns on the platform in accordance with a larger programmatic advertising strategy. It allows for precise targeting based on entity data 128 and/or entity activity data 130, making it especially useful for business-to-business (B2B) or business-to-consumer (B2C) marketing campaigns. The content delivery application 120 delivers content items 134, such as a series of one or more advertisements, to an audience of entities 108 of the connection network platform 112 of the connection network system 100. The content delivery application 120 assist advertisers in delivering content and ads to a professional audience by leveraging user profiles, job titles, industries, and other entity data 128 and entity activity data 130 collected by the connection network platform 112.

The connection network platform 112 comprises various machine learning (ML) models, such as a ranking model 122. A ranking model 122 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 112 to surface the most relevant results or recommendations to users.

The connection network platform 112 comprises various ML models, such as a recommendation model 124. A recommendation model 124 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods to provide tailored content and product suggestions.

The server device 102 comprises, or has access to, one or more data stores 126. In particular embodiments, the connections networking system 102 may include a data store 126. The data store 126 may be used to store various types of information for the server device 102 and/or the connection network platform 112. In particular embodiments, the information stored in the data store 126 may be organized according to specific data structures. In particular embodiments, the data store 126 may be a relational, columnar, correlation, or other suitable database. Although this disclosure describes or illustrates particular types of databases, this disclosure contemplates any suitable types of databases. Particular embodiments may provide interfaces that enable a client device 104 or a connection network system 100 to manage, retrieve, modify, add, or delete, the information stored in the data store 126.

In one embodiment, for example, the data store 126 stores entity data 128 for the connection network platform 112. In particular embodiments, the connection network platform 112 may include entity data 128 for various entities of the connection network platform 112. Non-limiting examples of entities may include users, individuals, members, businesses, companies, organizations, software agents, hardware agents, and so forth. For example, the entity data 128 may comprise one or more user profiles associated with users of the connection network platform 112. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 126 stores entity activity data 130 for the connection network platform 112. The entity activity data 130 represents various activities recorded for an entity 108 by the connection network platform 112. In particular embodiments, the connection network platform 112 may provide entities (e.g., users) with the ability to take actions on various types of items or objects supported (or accessible) by connection network platform 112. As an example and not by way of limitation, the items and objects may include groups or connections networks to which users of the connection network platform 112 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 112 or by an external system of a third-party system, which is separate from the server device 102 and coupled to the server device 102 via a network 106.

In one embodiment, for example, the data store 126 stores connection graph data 132 for the connection network platform 112. The connection network platform 112 may store connection graph data 132 for one or more users (e.g., members with subscription accounts) of the connection network platform 112. In one embodiment, for example, connection graph data 132 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 112 may provide users of the online connection network system 100 the ability to communicate and interact with other users. In particular embodiments, users may join the online connection network platform 112 via the connection network system 100 and then add connections (e.g., relationships) to a number of other users of the connection network platform 112 to whom they want to be connected. Herein, the term “connection” may refer to any other user of the connection network platform 112 or the connection network system 100 with whom a user has formed a friendship, association, or relationship via the connection network platform 112.

In one embodiment, for example, the data store 126 stores content items 134 for the connection network platform 112. The content items 134 may comprise any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 112 also includes user-generated content (UGC) objects, which may enhance a user's interactions with the connection network platform 112. User-generated content may include anything a user can add, upload, send, message, or “post” to the connection network platform 112. As an example and not by way of limitation, a user communicates posts to the connection network platform 112 from a client device 104. Posts may include data such as status updates or other textual data, articles, job openings, company information, awards, location information, photos, videos, links, music or other similar data or media. Content may also be added to the connection network platform 112 by a third-party through a “communication channel,” such as a newsfeed or content stream.

The connection network system 100 comprises a client device 104. In particular embodiments, a client device 104 may be an electronic device including hardware, software, or embedded logic components or a combination of two or more such components and capable of carrying out the appropriate functionalities implemented or supported by a client device 104. As an example and not by way of limitation, a client device 104 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 104. A client device 104 may enable a network user at a client device 104 to access a network 106. A client device 104 may enable its entity 108 to communicate with other entities 108 at other client devices 104, such as via messaging application 118.

The connection network system 100 comprises a client application 110. In particular embodiments, a client device 104 may include a client application 110, which may be a web browser, and may have one or more add-ons, plug-ins, or other extensions. An entity 108 at a client device 104 may enter a Uniform Resource Locator (URL) or other address directing a web browser to a particular server device 102 such as a server or server data center for a connection network platform 112, and the web browser may generate a Hyper Text Transfer Protocol (HTTP) request and communicate the HTTP request to the server device 102. The server device 102 may accept the HTTP request and communicate to a client device 104 one or more Hyper Text Markup Language (HTML) files responsive to the HTTP request. The client device 104 may render a web interface (e.g. a webpage) based on the HTML files from the server for presentation via an electronic display of the client device 104 to the entity 108. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 110 may be an application operable to provide various computing functionalities, services, and/or resources, and to send data to and receive data from the other entities of the network 106, such as the connection network platform 112. For example, the client application 110 may be a client connection network application tightly integrated with the connection network platform 112, a messaging application 118 for messaging with entities 108 of a messaging network or system, a web browser application, an internet searching application, and so forth.

In particular embodiments, the client application 110 may be storable in a memory and executable by a processor circuitry of the client device 104 to render user interfaces, receive user input, send data to and receive data from the connection network platform 112. The client application 110 may generate and present user interfaces to a user via an electronic display of the client device 104. For example, the client application 110 may generate and present a GUI 136 based at least in part on information received from the server device 102, the connection network platform 112, and/or another device or system (e.g., a third party server) via the network 106.

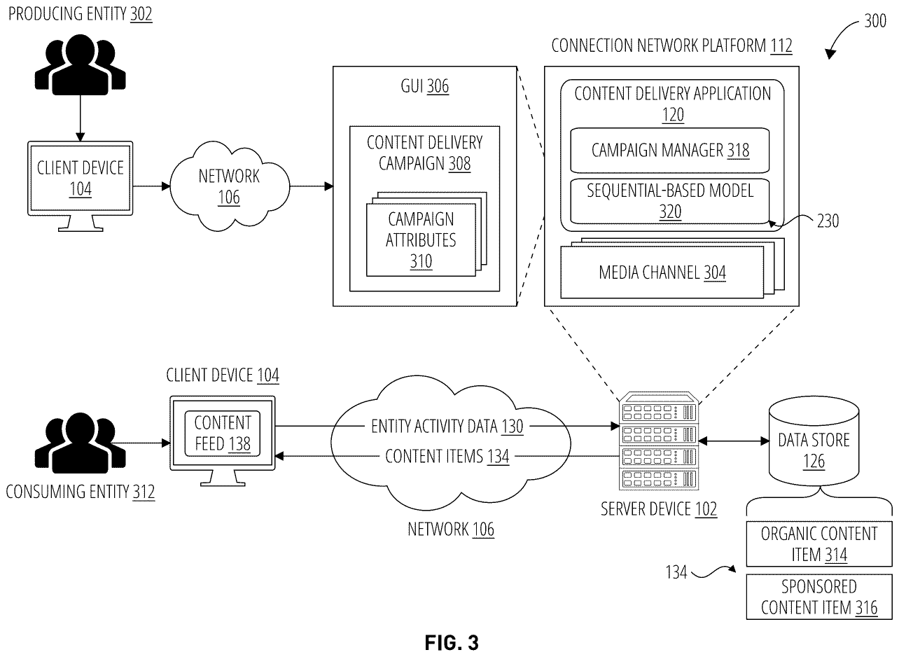

In some embodiments, the connection network platform 112 and/or the client application 110 and/or an operating system of the client device 104 may generate a GUI 136 on an electronic display of the client device 104. The client application 110 may receive one or more content items 134 from the data store 126 of the connection network platform 112 from the content delivery application 120. The client application 110 may display the content items 134 as content items 140 on a content feed 138 of the GUI 136. The content items 140 may include a feedback element 152 that when selected or activated by the entity 108, causes the GUI 136 to generate a signal such as a message for delivery to the content delivery application 120 of the connection network platform 112. The signal or message may comprise a feedback signal to the content delivery application 120 for use by the content delivery application 120 to select a new content item from the data store 126 for delivery to the client device 104. For example, the content delivery application 120 may use the feedback signal as part of an ML model to select content items 134 for a marketing campaign managed by the content delivery application 120, as described in more detail with reference to FIG. 3.

The connection network system 100 comprises a network 106. This disclosure contemplates any suitable network 106. As an example and not by way of limitation, one or more portions of a network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 106 may comprise multiple networks 106.

In operation, an entity 108 interacts with a client application 110 of the client device 104 to access applications and services provided by a connection network platform 112 of the server device 102 via one or more links 154 of the network 106. The links 154 may connect each client device 104 to the connection network platform 112 via the network 106. This disclosure contemplates any suitable link 154. In particular embodiments, one or more links 154 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 154 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 154, or a combination of two or more such links 154. Links 154 need not necessarily operate at the same throughout. One or more first links 154 may differ in one or more respects from one or more second links 154.

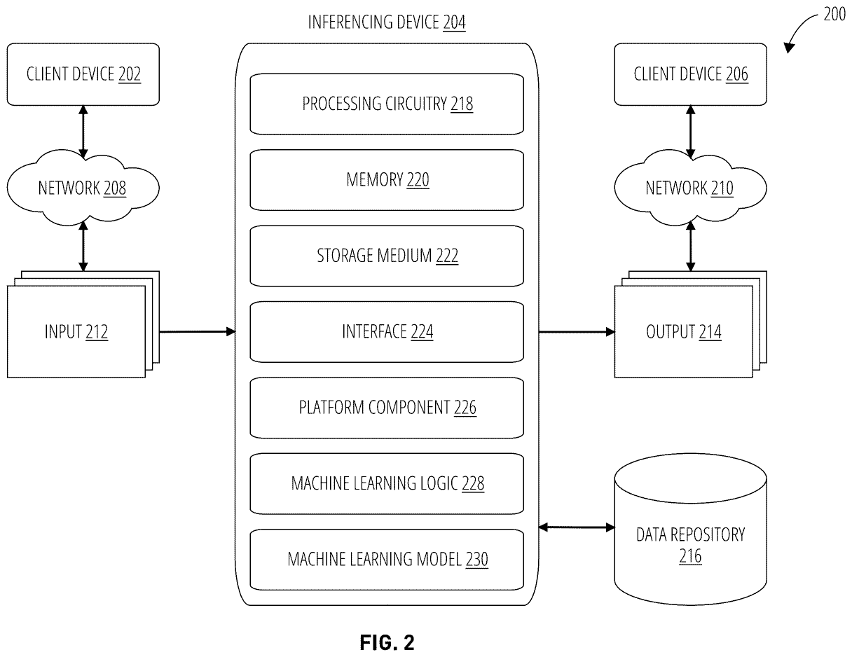

FIG. 2 illustrates an embodiment of a system 200. The system 200 is suitable for implementing one or more embodiments as described herein. In one embodiment, for example, the system 200 is an AI/ML system suitable for implementing models described with reference to any of the preceding description.

The system 200 comprises a set of M devices, where M is any positive integer. FIG. 2 depicts three devices (M=3), including a client device 202, an inferencing device 204, and a client device 206. The inferencing device 204 communicates information with the client device 202 and the client device 206 over a network 208 and a network 210, respectively. The information may include input 212 from the client device 202 and output 214 to the client device 206, or vice-versa. In one alternative, the input 212 and the output 214 are communicated between the same client device 202 or client device 206. In another alternative, the input 212 and the output 214 are stored in a data repository 216. In yet another alternative, the input 212 and the output 214 are communicated via a platform component 226 of the inferencing device 204, such as an input/output (I/O) device (e.g., a touchscreen, a microphone, a speaker, etc.).

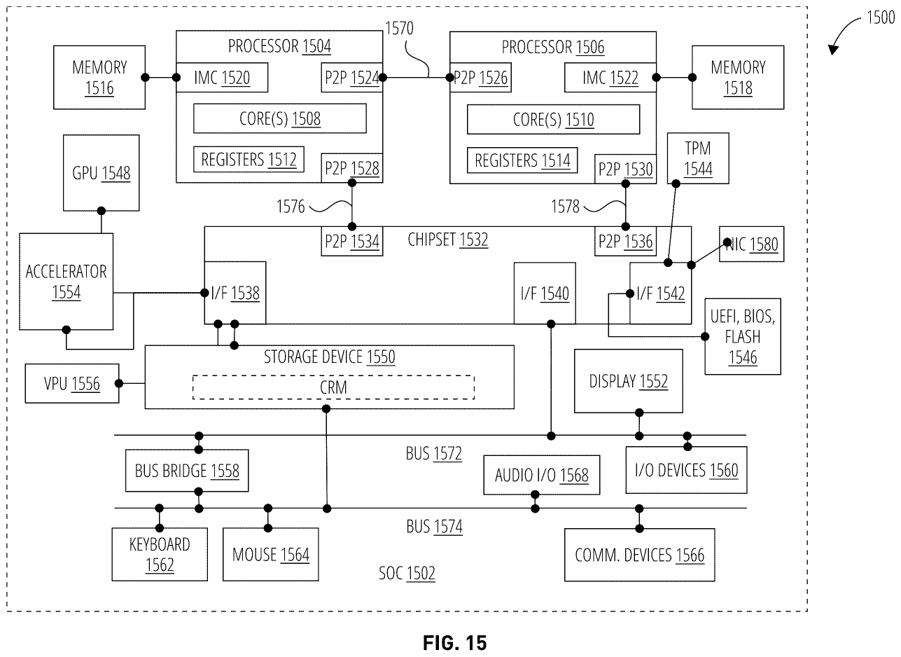

As depicted in FIG. 2, the inferencing device 204 includes processing circuitry 218, a memory 220, a storage medium 222, an interface 224, a platform component 226, ML logic 228, and an ML model 230. In some implementations, the inferencing device 204 includes other components or devices as well. Examples for software elements and hardware elements of the inferencing device 204 are described in more detail with reference to a computing architecture 1500 as depicted in FIG. 15. Embodiments are not limited to these examples.

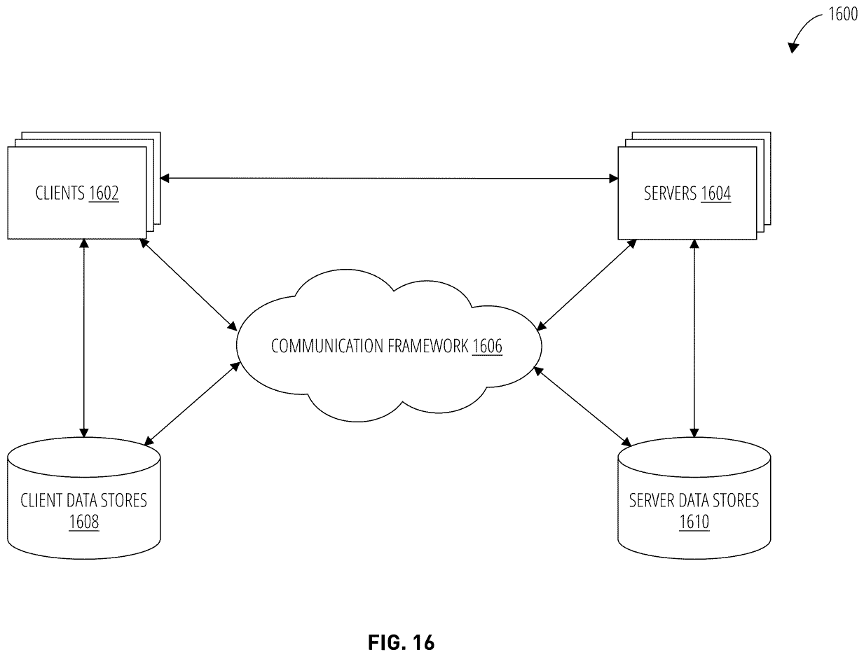

The inferencing device 204 is generally arranged to receive an input 212, process the input 212 via one or more AI/ML techniques, and send an output 214. The inferencing device 204 receives the input 212 from the client device 202 via the network 208, the client device 206 via the network 210, the platform component 226 (e.g., a touchscreen as a text command or microphone as a voice command), the memory 220, the storage medium 222 or the data repository 216. The inferencing device 204 sends the output 214 to the client device 202 via the network 208, the client device 206 via the network 210, the platform component 226 (e.g., a touchscreen to present text, graphic or video information or speaker to reproduce audio information), the memory 220, the storage medium 222 or the data repository 216. Examples for the software elements and hardware elements of the network 208 and the network 210 are described in more detail with reference to a communications architecture 1600 as depicted in FIG. 16. Embodiments are not limited to these examples.

The inferencing device 204 includes ML logic 228 and an ML model 230 to implement various AI/ML techniques for various AI/ML tasks. The ML logic 228 receives the input 212, and processes the input 212 using the ML model 230. The ML model 230 performs inferencing operations to generate an inference for a specific task from the input 212. In some cases, the inference is part of the output 214. The output 214 is used by the client device 202, the inferencing device 204, or the client device 206 to perform subsequent actions in response to the output 214.

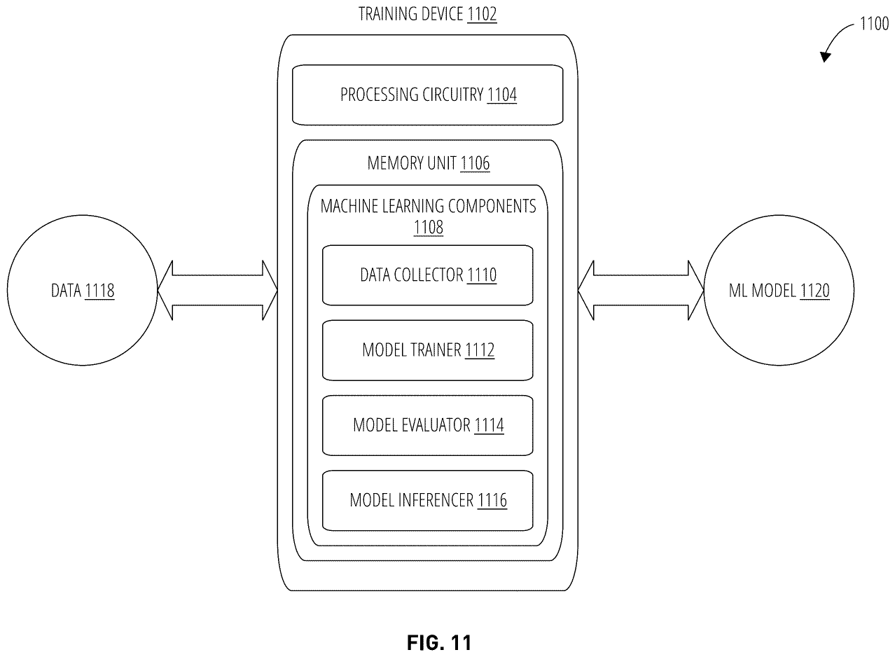

In various embodiments, the ML model 230 is a trained ML model 230 using a set of training operations. An example of training operations to train the ML model 230 is described with reference to FIG. 11.

FIG. 3 illustrates a content delivery system 300. The content delivery system 300 is an example of a system designed to deliver one or more content items 134 such as one or more organic content item 314 and/or sponsored content item 316 to a consuming entity 312 of the connection network platform 112 of the connection network system 100. The content delivery system 300 delivers the content items 134 in a targeted manner. The content items 134 may comprise, for example, recommendations, advertisements, content, messages, suggestions, hyperlinks, files, job postings, articles, and any other content offered by the connection network platform 112 of the connection network system 100.

In various embodiments, the connection network system 100 may use the content delivery system 300 to provide a content delivery service via a content delivery application 120 (e.g., software as a service (Saas)) to its entities 108 (e.g., individuals, members, entities, groups, etc.). The content delivery system 300 is generally designed to deliver electronic content items 134 to entities 108 based, at least in part, on entity data 128 and entity activity data 130 of entities 108 of the connection network system 100. In particular, the content delivery system 300 may deliver content items 134 such as organic content items 314 and/or sponsored content items 316 specifically targeted to an audience of entities 108 based on entity data 128 or entity activity data 130. For instance, a content producer such as an advertiser may create a content delivery campaign 308 such as a marketing campaign or advertising campaign to deliver a series of sponsored content items 316 for a product or service of a business entity to a consuming entity 312 of the connection network system 100 over a defined time interval (e.g., weeks, days, months, etc.). The content producer defines, controls, or manages the content delivery campaign 308 using a set of campaign attributes 310. The campaign attributes 310 may include various objectives of the content delivery campaign 308, such as increasing exposure, revenue, engagement, reach, and so forth.

The content delivery system 300 comprises a set of one or more client devices 104, server devices 102, and data stores 126. A client device 104 and a server device 102 may communicate information via a network 106. The client device 104 may comprise an electronic device, such as a smartwatch, smartphone, tablet, laptop computer, desktop computer, and so forth. The server device 102 may be implemented as a server in a data center, such as a cloud computing system or edge computing system. The client device 104 and the server device 102 may be implemented using an architecture as described in FIG. 15. The network 106 may be implemented using an architecture as described in FIG. 16. Embodiments are not limited to these example implementations.

The server device 102 implements a connection network platform 112 as described with reference to FIG. 1. In one embodiment, the connection network platform 112 includes at least one processor circuitry, at least one memory unit operably coupled to the processor circuitry, the memory unit including instructions executable by the at least one processor circuitry, and an ML model 230 comprising parameters and/or hyperparameters stored in the at least one memory unit. In one embodiment, for example, the ML model 230 is implemented as a two-tower ML model for an AI system implemented by the content delivery system 300 to offer a network service such as a content delivery service by the content delivery application 120 of the connection network platform 112. The content delivery application 120 may select one or more content items 134, such as organic content items 314 and/or organic content items 314, for delivery as targeted content over one or more media channels 304 to a client device 104. A GUI 136 may present the content items 134 in a content feed 138 on the client device 104. An entity 108 from the consuming entity 312 may interact with a GUI element of the GUI 136 to access the targeted content, such as scrolling through the content feed 138 in an X, Y or Z dimension to view the content items 134, clicking on an organic content item 314 or sponsored content item 316 for further inspection, providing feedback using a feedback element 152, and other activities.

The server device 102 may include connection network platform 112 implementing a network service to entity 108 of the connection network platform 112. Professional networking platforms offer a wide range of networking services to facilitate connections, career development, and knowledge sharing. Some examples of a network service offered by the connection network platform 112 include without limitation: (1) users can create a professional profile to showcase their skills, work experience, education, and professional accomplishments; (2) users can connect with colleagues, industry professionals, and potential employers to expand their professional network; (3) messaging capabilities for direct communication between users, facilitating professional conversations and networking opportunities; (4) users can join and participate in industry-specific groups and communities to engage in discussions, share insights, and network with like-minded professionals; (5) search job listings and recruiting tools for users to search for employment opportunities, apply for jobs, and connect with talent; (6) users can share industry-related content, articles, and professional updates to showcase expertise and engage with their network; and (7) access learning resources, courses, and training programs to support ongoing professional development and skill enhancement. These networking services are designed to help professionals connect, collaborate, and grow their careers. Embodiments are not limited to these examples.

In an example process, the connection network platform 112 obtains entity activity data 130 from entities 108 via the client device 104. The entities 108 interact with the connection network platform 112 via a user interface of the connection network platform 112. In some cases, portions of the user interface are displayed on a personal machine or client device 104 of an entity 108. The entity activity data 130 represents various actions, activities or behaviors of one or more entities 108 of the consuming entity 312. For example, entity activity data 130 may represent data collected as the entities 108 interact with various content items 134, such as content items 134, of the data store 126 served via the server device 102. In another example, the entity activity data 130 may represent data collected as the entities 108 interact with other products or services offered by the connection network platform 112, such as searching for job postings, sending messages to entities 108, recommending posts by entities 108, sending and responding to connection requests, playing online games, and other activities organic to use of the connection network platform 112. Session data is any entity activity data 130 collected during a defined session time window, such as activity of the user over a 24 hour period or some other time interval. For example, an entity 108 of the consuming entity 312 may interact with the client device 104 to communicate with the connection network platform 112 of one or more of the server devices 102 to access one or more content items 134 stored by the data store 126. The entities 108 may perform various activities, such as browsing a web site, searching for a job posting, reading content, watching a streaming video, messaging other members, clicking on an GUI item, interacting with an advertisements, or engaging in electronic commerce. The session data, including the entity activity data 130, is transferred between the client device 104 and the server device 102.

More particularly, the connection network platform 112 comprises the content delivery application 120, which includes or accesses an ML model 230, and data for one or more media channels 304. In particular embodiments, the content delivery system 300 uses multiple ML models 230 to support various downstream tasks for the content delivery application 120. One example of an ML model 230 is a sequential-based model 320 using one or more MMOE and associated gates, as described further herein. Embodiments are not limited to these examples of ML model 230.

The content delivery application 120 is responsible for delivery of targeted content based on entity activity data 130 and/or session data associated with the entities 108 of the consuming entity 312. The content delivery application 120 uses the multiple ML models 230 to support such activities. The content delivery application 120 then targets delivery of specific content items 134 to users within user segments, such as organic content items 314 and/or sponsored content items 316 for the consuming entity 312, over one or more media channels 304 for presentation on the content feed 138 of the GUI 136. The targeted content is a content item that is relevant to the consuming entity 312 or the consuming entity 312 segment, such as messages, predictions, recommendations, advertisements, or suggestions to improve user experience.

The content delivery application 120 may include a campaign manager 318. The campaign manager 318 manages the content delivery campaign 308 and campaign attributes 310. For example, the campaign manager 318 may include a reporting function that receives metrics from the ML model 230. Examples of metrics may include inflation values or deflation values associated with member-based attributed events estimated using privacy-safe or privacy-constrained group-level data. The producing entity 302 and/or the campaign manager 318 may modify the campaign attributes 310 based on the received metrics.

The targeted content is delivered through one or more of the media channels 304. A media channel refers to a specific platform or medium through which targeted content, such as advertisements, are disseminated to a target user. Media channels 304 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively. message provider, such as advertisers, often choose certain media channels based on factors such as user engagement, reach, cost, and the compatibility of the channel with their target market. An example of the media channel 304 is a social media platform or a professional media platform, or some other mode of information transfer within the platform.

The connection network platform 112 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

The data store 126 is an organized collection of data. For example, the data store 126 stores data in a specified format known as a schema. The data store 126 can be structured as a single database, a distributed database, multiple distributed databases, or an emergency backup database. In some cases, a database controller manages data storage and processing in data store 126. In some cases, a user interacts with the database controller. In other cases, the database controller operates automatically without user interaction. The data store 126 is configured to store various content items 134. The content items 134 include any multimedia information suitable for presentation by the client device 104, such as HTML code to present websites, text, images, video, messages, advertisements, and so forth. In addition, the data store 126 may also store application data comprising information and data used by the connection network platform 112. For example, data store 126 is configured to store user session data, profiles, embeddings, budgets, cached application programming interface (API) requests, machine learning model parameters, training data, and other data.

Network 106 facilitates the transfer of information between connection network platform 112, data store 126, and client device 104. Network 106 is a computer network configured to provide on-demand availability of computer system resources, such as data storage and computing power. In some examples, the network 106 provides resources without active management by the entities 108. The network 106 includes data centers available to many users over the Internet. Some large cloud networks have functions distributed over multiple locations from central servers. A server is designated an edge server if it has a direct or close connection to an entities 108. In some cases, a cloud is limited to a single organization. In other examples, the cloud is available to many organizations. In one example, the network 106 includes a multi-layer communications network comprising multiple edge routers and core routers. In another example, the network 106 is based on a local collection of switches in a single physical location.

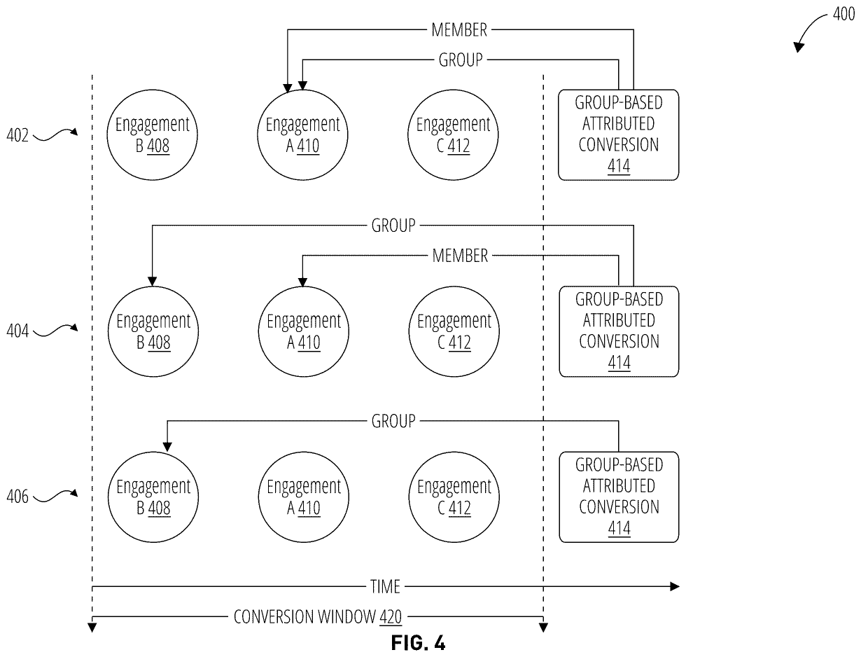

FIG. 4 illustrates a logic diagram 400. The logic diagram 400 is an example of multiple scenarios that may define, affect, or impact member-based attribution for an ML model 230, such as a sequential-based model 320. Embodiments are not limited to these example scenarios.

As previously described, the content delivery system 300 uses the ML model 230 to perform sequential-based prediction over a conversion window 420 of time T at a conversion event level. When attributing at the group level, there could be three types of attributed results when compared to members.

As depicted in FIG. 4, the logic diagram 400 illustrates a scenario 1 402, a scenario 2 404, and a scenario 3 406. Assume there is a group-based attributed conversion 414. In scenario 1 402, both member and group conversion are attributable. For example, the group-based attributed conversion 414 is attributed to an Engagement A 410 for both group engagement and member engagement. The group and member engagement attribution are the same. In this case, the group-attributed conversion is not inflated.

In the scenario 2 404, similar to scenario 1 402, both member and group conversion are attributable. However, the group and member engagement attributions are different. For example, the group-based attributed conversion 414 is attributed to an Engagement A 410 for member engagement and Engagement B 408 for group engagement. The group and member engagement attribution are different. In this case, the group-attributed conversion is not inflated, but the attributed engagement is misleading.

In the scenario 3 406, the group conversion is attributable and the member conversion is not attributable. For example, the group-based attributed conversion 414 is attributed to Engagement B 408 for group engagement and there is no attribution for member engagement. In this case, the group-attributed conversion is inflated.

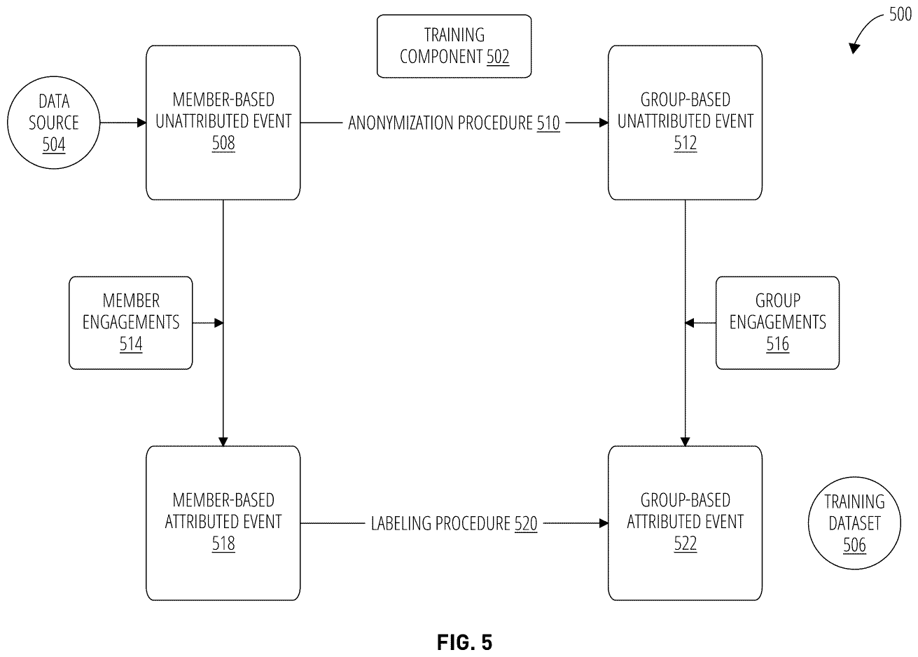

FIG. 5 illustrates a logic diagram 500. The logic diagram 500 is an example of a procedure to generate labels for training datapoints in a training dataset suitable for training an ML model 230, such as a sequential-based model 320. Embodiments are not limited to this example.

As depicted in FIG. 5, the logic diagram 500 illustrates a training component 502 for an ML model 230. The training component 502 comprises a data source 504 to source data, such as entity data 128 and/or entity activity data 130, suitable for training the ML model 230. The training component 502 uses a training algorithm that models a group-to-member attributed conversion inflation rate. The training component 502 constructs training labels on placement and platform where there is member deterministic conversion. The training component 502 labels group attributed conversion events with member deterministic attributed conversion as a training label.

For training label construction for modeled conversions, the data source 504 includes one or more member-based unattributed events 508 and member-based attributed events 518. The member-based attributed events 518 may include engagement information, such as member engagements 514. In addition, the data source 504 includes one or more group-based unattributed events 512 and group-based attributed events 522. The group-based attributed events 522 may include engagement information, such as group engagements 516.

The training component 502 labels an anonymized group attributed conversion with member deterministic attributed results. In some case, however, there might not be an actual member-level attributed conversion underneath the group attributed events, due to the group-level conversion attribution inflation problem. On an aggregation level, anonymous conversion attributed events inflated member-based attributed conversions by over 3 times.

In a first step, the training component 502 uses an anonymization procedure 510 that anonymizes member-based unattributed events 508 and external conversion tracking events with a group-based identity. The anonymization procedure 510 anonymizes member engagements 514 and member external conversion events and performs group-based last-touch attribution.

In a second step, the training component 502 performs group-based last touch conversion attribution. For example, the training component 502 uses a labeling procedure 520 that labels group-based attributed events 522 with member-based deterministic attribution results with corresponding member-based attributed conversion counts. The labeling procedure 520 removes unattributable events. For example, assume a data structure such as a table includes columns for member external conversion events and group external conversion events. For the member external conversion events, each row comprises a member identifier (MID) (e.g., MID=123), a boolean value indicating whether the MID has an engagement within a conversion window (e.g., Y or N), a number of external conversions (e.g., 1, 2, 3, etc.), and a boolean value indicating whether the MID has attributable conversions (e.g., Y or N). For the group external conversion events, each row comprises a group identifier (GID) (e.g., abc), a boolean value indicating whether the GID has an engagement within a conversion window (e.g., Y or N), a number of external conversions (e.g., 1, 2, 3, etc.), and a boolean value indicating whether the GID has attributable conversions (e.g., Y or N). For group-based last touch attribution, the training component 502 removes rows where a MID does not have an engagement within the conversion window (e.g., value=N) and the MID has no attributable conversions (e.g., value=N), and a GID does not have an engagement within the conversion window (e.g., value=N) and the GID has no attributable conversions (e.g., value=N).

In a third step, once rows are removed from the table, the training component 502 adds ground truth labels to the remaining rows for split tracking group conversion attribution. For example, the group external conversion events, another column is added for whether the GID has ground truth conversions. Each row includes a boolean value indicating whether the GID has a ground truth conversion (e.g., a Y or N).

In this manner, the training component 502 generates a training dataset 506 from datapoints obtained or generated from the data source 504 that links group-based attribution results back to corresponding member-based attribution at a conversion event level consistent with outcomes from scenario 1 402, scenario 2 404, and scenario 3 406 as described with reference to FIG. 4.

In the first step, for example, the training component 502 conducts group conversion attribution with an any touch method. In order to differentiate the scenario 1 402 and scenario 2 404, the training component 502 performs an any touch conversion attribution method for group-based attribution. The training component 502 associates per group conversions with all group engagement footprints within an advertiser conversion window. In addition, the training component 502 labels when the group engagement footprint is a last-touch or not.

In the second step, for example, the training component 502 matches with both conversion and engagement events attributes. The training component 502 compares all group engagement footprints with member last-touch attribution results. If the training component 502 finds a group any-touch result that matches a member last-touch, but it is not a group last-touch, then the training component 502 labels the group based conversion as a scenario 2 404. If the training component 502 finds group last-touch results matches member last-touch results, then the training component 502 labels them as a scenario 1 402. If the training component 502 cannot find any member last-touch result matching a group any-touch attribution, the training component 502 labels it as an inflated conversion, namely scenario 3 406.

At a high-level, a labeling scope includes generating a member deterministic label where both engagement and conversion are available at a member-level, regardless of placements and platforms (e.g., excluding ODA).

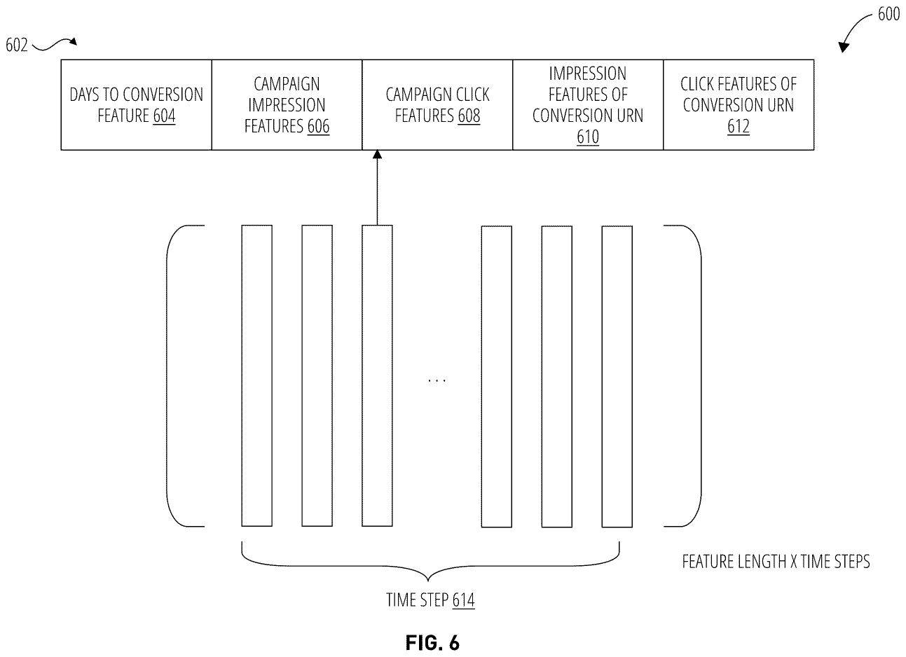

FIG. 6 illustrates a logic diagram 600. The logic diagram 600 is an example of an activity sequence 602 suitable as input to an ML model 230, such as a sequential-based model 320 for the content delivery application 120. Embodiments are not limited to this example.

Once the training component 502 trains the ML model 230, the trained ML model 230 is deployed to a production server for the content delivery system 300 for inferencing operations for a massive web-scale online system, such as a connection network system 100. In some embodiments, for example, the ML model 230 is implemented as a sequential-based model 320. The model task for the sequential-based model 320 is to predict the probability of the existence of deterministic member-based conversion event for each cohort-based conversion event. In some embodiments, for example, the target variable for the sequential-based model 320 is a binary variable, such as a 1 or 0. For each cohort-based conversion event whether there is an underlying deterministic member-based conversion event, the target variable is assigned a value of 1 for having member-based conversion event and a value of 0 for none.

At a high-level, the sequential-based model 320 is a supervised learning model designed to predict a group-to-member conversion inflation factor. Specifically, the sequential-based model 320 has a modeling goal of predicting the over/under inflation caused by group-based conversion attribution compared to member-identity attribution. When applying modeled conversion prediction on platform and placement where there is no member deterministic data, the sequential-based model 320 assumes that extrapolating the group inflation behavior would be the same for other platforms and placement where there is no member deterministic data for inference operations.

In some embodiments, the sequential-based model 320 is a deep learning model with engagements as sequential features for modeled conversions. Group-based conversion attribution leads to inflated attributed conversions, as compared to member-based conversion attribution. The sequential-based model 320 predicts the inflation factors, and applies the inflation factors to deflate group-based conversions.

As depicted in FIG. 6, the logic diagram 600 is an example of sequential features. Specifically, the logic diagram 600 illustrates an activity sequence 602 comprising sequence features suitable as input to an ML model 230, such as a sequential-based model 320, for the content delivery application 120. The sequential-based model 320 models engagements as a time series, and it learns the sequence features within layers of the sequential-based model 320. For example, the sequential-based model 320 is designed to use engagements in lieu of events, which provides additional information about dependency and time patterns among engagements. For each conversion event, the activity sequence 602 includes sequential features over a defined conversion window 420 (e.g., 90 days) for associated <group, campaign> and <group, groupurn>level engagement (e.g., impressions, clicks, etc.) features extracted from data for group engagements 516.

A set of sequence features may comprise a feature length multiplied by a defined number of time steps. Each time step 614 represents one engagement and comprises 5 types of feature categories, including a days to conversion feature 604, campaign impression features 606, campaign click features 608, impression features of conversion urn 610, and click features of conversion urn 612. For the days to conversion feature 604, time steps 614 in the activity sequence 602 are ranked by a gap between a lead time and a conversion time in a descending order. For example, a time step 614 may comprise daily engagements up to a length defined for the conversion window 420 (e.g., 90 days). The sequential-based model 320 allows varied time steps for each conversion event, which is achieved via zero padding at the end of the sequence feature. The campaign impression features 606 category aggregates impression features of the content delivery campaign 308, to which the conversion is attributed. The campaign click features 608 category aggregates click features of the content delivery campaign 308, to which conversion is attributed. The impression features of conversion urn 610 category aggregates impression features of campaigns in the same conversion URN for certain group URN. The click features of conversion urn 612 category aggregates click features of campaigns in the same conversion URN for a certain group URN. In some embodiments, the activity sequence 602 may include a sixth feature category, such as engagement features (not shown). This feature category includes engagement features to which the conversion is attributed.

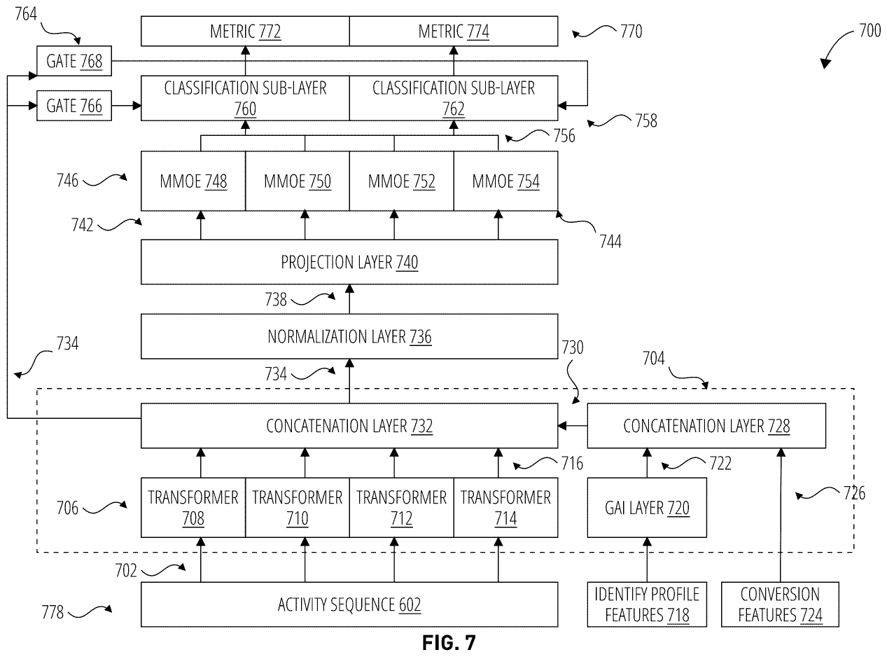

FIG. 7 illustrates an ML architecture 700. The ML architecture 700 is an example ML framework for an ML model 230, such as the sequential-based model 320. In some embodiments, the sequential-based model 320 may be implemented as a combination of an RNN structure and an MLP structure. In some embodiments, the sequential-based model 320 may be implemented using a combination of a MMOE structure and transformer structure in replacement of the RNN structure and the MLP structure. The ML architecture 700 is an example of the latter case. Embodiments are not limited to these examples.

As previously described, the sequential-based model 320 generates sequential-based predictions at a conversion event level. Specifically, for each cohort-based conversion event, the sequential-based model 320 predicts a probability of whether there is a deterministic member-based conversion event. In some embodiments, the sequential-based model 320 generates a target binary variable set to a value of 1 or 0. For example, the value 1 represents the existence of a deterministic member-based conversion event for a cohort-based conversion event, and the value 0 represents the non-existence (or absence) of a deterministic member-based conversion event for the cohort-based conversion event, or vice-versa. When the sequential-based model 320 outputs a value of 1, this means the cohort-based conversion event is not inflated (e.g., scenario 1 or scenario 2). However, when the sequential-based model 320 outputs a value of 0, this means the cohort-based conversion event is inflated (e.g., scenario 3). For example, assume a scenario where there is member-level data and it indicates that there are actually 10 conversion events attributed to a member ID for a given content delivery campaign. In the absence of member-level data, assume a model uses group-level data and it estimates that there are 100 conversion events attributed to a member ID for the same content delivery campaign. In this scenario, the model inflates a number of attributed conversions by 10×. In various embodiments, the ML model 230 may be implemented as a deep learning model. In some embodiments, for example, the ML model 230 is a sequential-based model 320 using a transformer and one or more multi-gate mixture-of-experts (MMOE) models to jointly predict inflation for multiple metrics reported to a campaign manager 318. The sequential-based model 320 generates an “any touch” and “last touch” contrast-based event level inflation label. The MMOE with multi-transformer architecture is designed for joint inflation predictions across multiple conversion outcomes, such as web conversions, LGF, and qualified leads, and other outcomes. The gate weights are learned during the model training phase. During inference, these weights are dynamically computed based on the model input, making them sample-dependent rather than manually fixed. Leveraging a generative AI model (GAI) such as a large language model (LLM) encoder, the sequential-based model 320 takes member profiles belonging to the probabilistic identity (e.g., a private group) or the exact identity and extracting the corresponding embedding for the members belonging to the group via the mean pool, concatenation, or element-wise Hadamard product. Transformer output compression is implemented for efficient training and inference.

As depicted in FIG. 7, the ML architecture 700 takes an input vector 778. The input vector 778 may include values representing various features for processing by the sequential-based model 320. In some embodiments, for example, the input vector 778 comprises a set of sequence features for a group of entities, a set of identity profile features for the group of entities, and a set of conversion features. The set of sequence features for a group of entities may include activity features from an activity sequence 602 as described with reference to FIG. 6. The set of identity profile features for the group of entities may include text from member profiles belonging to a probabilistic identity (e.g., a private group) or the exact identity for the group of entities. The set of conversion features are associated with conversion events, such as a type of conversion, a conversion format, conversion device type, a conversion time, and other conversion attributes.

The input vector 778 is received by a transformer layer 704 of the sequential-based model 320. The transformer layer 704 transforms the input vector 778 to an output vector suitable for further processing by an MMOE layer 744. In some cases, different portions of the transformer layer 704 processes different sets of features from the input vector 778 in parallel to accelerate predictions.

In some embodiments, for example, the input vector 778 may include an activity sequence 602 as described with reference to FIG. 6. For example, the sequential-based model 320 receives an activity sequence 602 comprising multiple sequence features 702. The activity sequence 602 is a single or cross-channel behavior sequence based on an exact identity or probabilistic identity (e.g., a private group). The sequential-based model 320 generates a first input vector 716 comprising a set of sequence features 702 for a group of consuming entities 312 using a transformer layer 704 of the sequential-based model 320.

The activity sequence 602 is input to a transformer layer 704 comprising a number of transformers 706, such as transformer 708, transformer 710, transformer 712, and transformer 714. A transformer 706 is a sequence-to-sequence deep learning model that uses attention mechanisms to handle long-range dependencies without relying on recurrent or convolutional architectures. It employs a multi-head self-attention mechanism, where each head computes a scaled dot-product attention over the input embeddings (augmented by positional encodings) to learn context-rich representations. These heads are then concatenated and passed through a feed-forward network (often a position-wise fully connected layer), with residual connections and layer normalization applied after both the attention and feed-forward sub-layers. This design improves parallelization, as all time steps can be processed simultaneously, and allows the model to efficiently capture global context, significantly advancing the state of the art in natural language processing and other sequence modeling tasks. Depending on the design, each transformer 706 is implemented using the same or similar architecture and trained on the same or similar training dataset. Despite these similarities, however, each transformer 706 generates a slightly different output from the same activity sequence 602, which are then combined to produce an average output. Outputs from the transformers 706 are fed into a concatenation layer 732 that concatenates the outputs into the first input vector 716. It is worthy to note that the number of transformers 706 implemented for the transformer layer 704 is variable, and embodiments are not limited to this example number of transformers.

By way of example, the activity sequence 602 may comprise a set of feature categories as set forth in Table 1.

TABLE 1

| Feature Category | Feature Name | Comments |
|---|---|---|
| Campaign impression features | impRtb | This feature category |
| | impInterstitial | aggregates impression |
| | impAdformat | features of the campaign, |
| | impExchange | which the conversion is |
| | impViral | attributed to. |
| | impCost | |
| | impOsfamily | |
| | presentationtype | |
| Campaign click features | clickRtb | This feature category |
| | clickInterstitial | aggregates click features of |
| | clickAdformat | the campaign, which the |
| | clickExchange | conversion is attributed to. |
| | clickViral | |
| | clickCost | |
| | clickOsfamily | |
| | clickPresentationtype | |
| | clicktag | |
| Conversion urn impression features | impCampaignCount | This feature category |
| | impConvurnRtb | aggregates impression |
| | impConvurnInterstitial | features of campaigns in |
| | impConvurnAdformat | the same conversion urn |
| | impConvurnExchange | for a certain cohortUrn. |
| | impConvurnViral | |
| | impConvurnCost | |
| | impConvurnOsfamily | |
| | impConvurnPresentationtype | |
| Conversion urn click features | clickCampaignCount | This feature category |
| | clickConvurnRtb | aggregates click features of |
| | clickConvurnInterstitial | campaigns in the same |
| | clickConvurnAdformat | conversion urn for a certain |
| | clickConvurnExchange | cohortUrn. |
| | clickConvurnViral | |
| | clickConvurnCost | |
| | clickConvurnOsfamily | |
| | clickConvurnPresentationtype | |
| | clickConvurntag | |
| Engagements features | enghour | This feature category is the |
| | engislan | engagement features that |
| | engchargetype | the conversion is attributed |
| | engoptimizationtarget | to. |
| | engobjectivetype | |
| | engosapptype | |
| Conversion features | convinsighttagformat | This feature category is |
| | convattributiontype | conversion-related features. |
| | convactiontype | |
| | convosapptype | |
| | convhour | |
| | convwindowtype | |
| | daysbetweenengagement | |
| | convdow | |

For the transformers 706 in the transformer layer 704, the input has a shape of (sequence length, input dimension) and the output has a shape of (sequence length, output dimension). Efficient compression is used for handling long sequences due to long history and fuzzy identity (sequence length >1k or >10k), as simple mean or max pooling can often result in information loss. The compression process starts by retaining the most recent K steps from the output to capture short-term user interest and intent. For the remaining steps, the compression process performs pooling that reflects the long-term user preference. Consequently, the output shape becomes (K+1, output dimension). It is worthy to note that the pooling length K can vary for different transformers. Formally, given the time-ordered transformer output c=concat [c₁, c₂, . . . , cₙ], the compressed output is expressed in Equation (1) as follows:

$$\underline{c} = concat [ pool ( {c}_{1} , {c}_{2} , … , {c}_{n - K} ) , {c}_{n - K + 1} , … , {c}_{n} ] \qquad EQUATION ( 1 )$$

In parallel, the transformer layer 704 of the sequential-based model 320 generates a second input vector 722 comprising a set of identity profile features extracted from identity profile features 718 for the group of consuming entities 312 using a GAI layer 720 of the sequential-based model 320. Since a group comprises a set of known consuming entities 312, data for each of the consuming entities 312 such as profile information (e.g., employer, education, job title, job description, experience, etc.) provides signals about characteristics of the consuming entities, including a probability that a consuming entity 312 would engage in a conversion event. In some embodiments, for example, the GAI layer 720 comprises a large language model (LLM) to receive as input textual information from the identity profile features 718 and generate as output textual information. The textual information is converted to values for the second input vector 722. The identity profile features 718 may comprise text from member profiles associated with the probabilistic identity. For example, an LLM encoder receives as input text from member profiles belonging to a probabilistic identity (e.g., a private group) or the exact identity and it extracts the corresponding embedding for the members belonging to the group via the mean pool, concatenation, or the element-wise Hadamard product.

Further, the transformer layer 704 of the sequential-based model 320 receives (or generates) a third input vector 726 comprising a set of conversion features 724. In addition to the sequential sequence features 702 of the activity sequence 602, the sequential-based model 320 may receive as input non-sequential features, such as a conversion features 724. This feature category includes conversion-related features. Examples of conversion features 724 include a conversion insight tag format, conversion attribution type, conversion action type, conversion OS application type, conversion hour, conversion window type, days between engagements, and other relevant conversion features.

A first concatenation layer 728 concatenates the second input vector 722 and the third input vector 726 into a first concatenated vector 730. A second concatenation layer 732 concatenates the second input vector 722 and the third input vector 726 of the concatenated vector 730 with the input vector 716 from the transformer 706 to form a second concatenated vector 734.

A normalization layer 736 of the sequential-based model 320 receives the concatenated vector 734 and it normalizes the second concatenated vector 734 to form a normalized vector 738. The normalization layer 736 standardizes the activations within the sequential-based model 320 to stabilize and accelerate training, typically by rescaling the inputs to have zero mean and unit variance, then applying learnable shift and scale parameters. For example, in batch normalization, the mean and variance are computed per feature map (channel) over a minibatch, while layer normalization computes these statistics across the feature dimension for each individual example. By reducing internal covariate shift (i.e., large shifts in input distributions across layers and training steps), normalization layers help maintain stable gradients, enable faster training convergence, and can improve overall generalization by acting as a form of regularization.

A projection layer 740 of the sequential-based model 320 receives the normalized vector 738 and it projects the normalized vector 738 to form a projected vector 742. The projection layer 740 is a linear transformation (with optional bias term) applied to map data from one vector space to another, often used to match dimensionalities or to reduce dimensionality before subsequent operations. Mathematically, it can be expressed as y=Wx+b, where x is the input vector or activation, W is a learned weight matrix, and b is a learned bias. By adjusting the size of W, the projection layer 740 can compress or expand the feature dimension to align with downstream components, making it useful in architectures such as transformers for projecting embeddings or in classification heads where the hidden state of a network is mapped to the desired output dimension.

An MMOE layer 744 of the sequential-based model 320 receives the projected vector 742 and it generates an MMOE vector 756. The MMOE layer 744 is a multi-task learning architecture that extends the classic Mixture-of-Experts approach by introducing multiple, task-specific gating networks. In this setup, a pool of “expert” sub-networks (often fully-connected layers) processes the input in parallel, each producing its own output representation. For each task, a dedicated gating network 764, such as gate 766 and gate 768, learns how to weight the outputs of these experts, typically via a softmax mechanism, to yield a task-specific combination of expert outputs. This allows shared parameterization within the experts while enabling each task to learn its own expert-weighting strategy, effectively leveraging cross-task information without forcing all tasks to share the same representation. The MMOE architecture often yields improved performance across multiple tasks by balancing knowledge sharing with task-specific specialization.

In some embodiments, for example, an MMOE 746 may be implemented as a combination of a deep and cross network (DCN) and a multilayer perceptron (MLP). However, embodiments may implement an MMOE 746 using other types of ML architectures and frameworks. Embodiments are not limited to this example.

A DCN is a dual-tower architecture that jointly models explicit feature interactions through a “cross” network and higher-order interactions through a “deep” network. The cross network applies multiple cross layers, each computing a bilinear interaction between a base input X₀ and the output of a previous layer X₁, formally expressed in Equation (2) as follows:

$${X}_{l} + 1 = {X}_{0} ( {X}_{l}^{T} {W}_{l} ) + {b}_{l} + {X}_{l} \qquad EQUATION ( 2 )$$

The cross layers create direct multiplicative feature interactions without substantial parameter overhead. Simultaneously, the deep network is a standard feed-forward stack that captures complex nonlinear relationships. The outputs of both the cross and deep towers are then combined (e.g., concatenated and fed to a final layer), providing a robust mechanism to incorporate both low-order and high-order feature interactions for tasks such as recommendation or prediction.

A MLP is a fully connected neural network composed of multiple layers of linear transformations and non-linear activations. Formally, each hidden layer computes Equation (3) as follows:

$${h}_{l} = f ( {W}_{l} {h}_{l - 1} + {b}_{l} ) \qquad EQUATION ( 3 )$$

In Equation (3), hₗ₋₁ is the input from the previous layer (with h₀) as the original input), W₁ and b₁ are learnable parameters, and ƒ(·) is a non-linear activation function such as rectified linear unit (ReLU) or sigmoid. The final layer often outputs predictions or logits depending on the task (e.g., classification, regression). MLPs are trained end-to-end using backpropagation and gradient-based optimization, and with sufficient depth and width, they can approximate a wide range of continuous functions, making them fundamental building blocks in many deep learning systems.

The MMOE layer 744 may comprise a number of MMOE 746, such as MMOE 748, MMOE 750, MMOE 752, and MMOE 754. Depending on the design, each MMOE 746 generates a slightly different output from the projected vector 742 which are combined to produce an average output. Outputs from the MMOE layer 744 are fed into a classification sub-layer 760. It is worthy to note that the number of MMOEs 746 implemented for the MMOE layer 744 is variable, and embodiments are not limited to this example number of MMOEs 746.

A set of classification layers 758 may receive the MMOE vector 756 from the MMOE layer 744 and generate different metrics 770 for a content delivery campaign 308 using the gating network 764. For example, when the gate 766 is open, a first classification sub-layer 760 of the sequential-based model 320 receives the MMOE vector 756 and it generates a first metric 772 based on the MMOE vector 756. For example, the first metric 772 may comprise a value indicating whether there is a deterministic entity level conversion event for a group level conversion event. For example, the metric 772 may represent a predicted inflation value for a number of qualified leads (QL) for the content delivery campaign 308. When the gate 768 is open, a second classification sub-layer 762 of the sequential-based model 320 receives the MMOE vector 756 and it generates a second metric 774 based on the MMOE vector 756. For example, the second metric 774 may represent a predicted inflation value for a number of web conversions (WC) for the content delivery campaign 308. There may be any number of classification layers 758 and/or classification sub-layers to generate different metrics 770 for different objectives associated with a given content delivery campaign 308. Embodiments are not limited to these examples.

In some embodiments, for example, the gates (e.g., gate 766 and/or gate 768) of the gating network 764 can be either dense or sparse. A dense gate has the form of a softmax function and yields a weighted sum of outputs from all experts. The sparse gate performs the topK operation, followed by additive random noise and then the softmax operation. It yields a weighted sum of outputs from only k experts. The hyper-parameter k is selected based on the specific application, with common choices being k=1 or k=2. The addition of a noise term is a prevalent strategy for the training of a sparsely-gated MoE layer, facilitating exploration among experts and enhancing the training stability. For example, let the input to each expert be x and the output from the ith expert as fᵢ(x), i=1, . . . , nₑₓₚₑᵣₜₛ. The output of the task m is Equation (4) as follows:

$${y}_{m} = {h}_{m} ( {\sum }_{i = 1}^{n} {{g}_{m} ( x )}_{i} {f}_{i} ( x ) ) \qquad EQUATION ( 4 )$$

In Equation (4), hₘ is a task-specific neural net and m=1, . . . , nₜₐₛₖ. Let Wm be the trainable weight matrices, the gates are a dense gate as in Equation (5) or a sparse gate as in Equation (6) as follows:

$${{g}_{m} ( x )}_{i} = softmax ( {W}_{m} x ) \qquad EQUATION ( 5 )$$

$${{g}_{m} ( x )}_{i} = softmax ( {W}_{m} x ) \qquad EQUATION ( 6 )$$

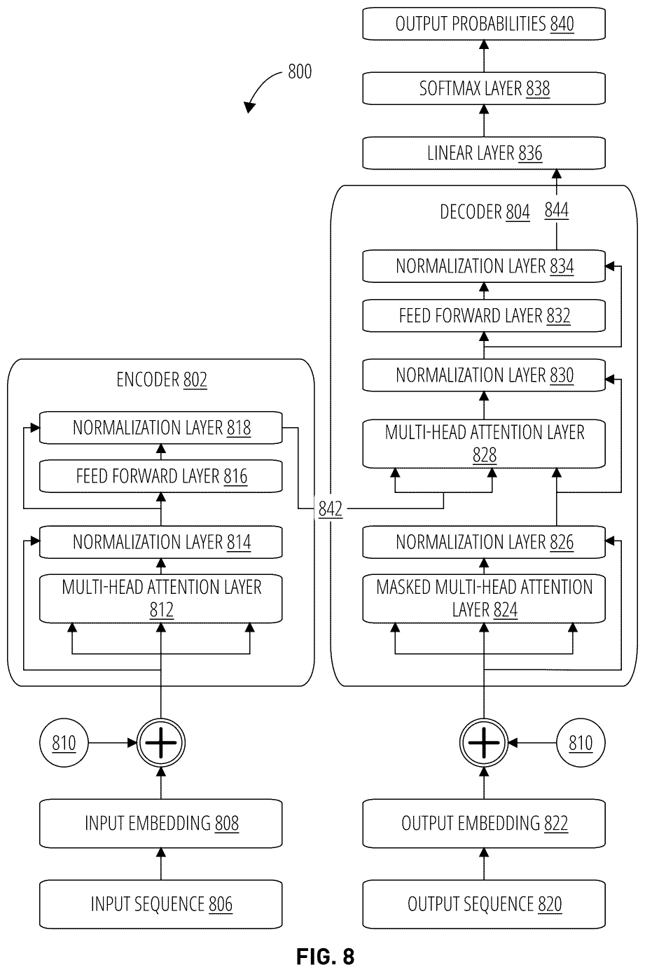

FIG. 8 illustrates a transformer model 800. The transformer model 800 is an example of a transformer architecture suitable for use by a transformer 706 and/or a GAI of a GAI layer 720 for an ML architecture 700 of a sequential-based model 320 for the content delivery system 300. In particular, the transformer model 800 is an example of a transformer architecture suitable for GPT, such as a version of ChatGPT, or a large language model (LLM). ChatGPT is trained on massive amounts of data, allowing it to generate text and respond to various prompts with human-like precision and accuracy. Embodiments are not limited to transformers.

As depicted in FIG. 8, the transformer model 800 comprises an encoder 802 and a decoder 804. The encoder 802 receives as input an input sequence 806, which is converted to an input embedding 808. A positional encoding 810 is added to the input embedding 808. The input embedding 808 with positional encoding 810 is input to the encoder 802. The encoder 802 comprises a multi-head attention layer 812, a normalization layer 814, a feed forward layer 816, and a normalization layer 818. The encoder 802 outputs an encoder output 842 to the decoder 804. The decoder 804 receives as input an output sequence 820, which is converted to an output embedding 822. A positional encoding 810 is added to the output embedding 822. The output embedding 822 with positional encoding 810 is input to the decoder 804. The decoder 804 comprises a masked multi-head attention layer 824, a normalization layer 826, a multi-head attention layer 828, a normalization layer 830, a feed forward layer 832, and a normalization layer 834.

Specifically, the encoder 802 is a neural sequence transduction model comprising an encoder 802 and a decoder 804. The encoder 802 receives an input sequence 806 and it translates the input sequence 806 into a lower-dimensional space. The encoder 802 maps an input sequence of symbol representations (x₁, . . . , xₙ) to a sequence of continuous representations z=(z₁, . . . , Zₙ). Given z, the decoder 804 then generates an output sequence (y₁, . . . , yₘ) of symbols one element at a time. At each step, the model is auto-regressive, consuming the previously generated symbols as additional input when generating the next. The decoder 804 translates the lower-dimensional data provided by the encoder 802 back to the original data format. Both the encoder 802 and the decoder 804 share three main types of layers, including a positional encoding layer, self-attention layer, and feedforward layer.

The encoder 802 transforms natural language input into numerical vectors. The encoder 802 receives an input sequence 806. The input sequence is a sequence of tokens (e.g., words or sub-words) that represent the text input. An input encoding layer of the encoder 802 converts the input sequence 806 into an input embedding 808. An input embedding 808 is a numerical representation of concepts converted to number sequences. The input embedding 808 is an NLP technique that represents words with vectors in such a way that once represented in a vectorial space, the mathematical distance between vectors is representative of the similarity among words they represent. For example, the content delivery application 120 may incorporate input embeddings to personalize, recommend, and search content. The input embedding 808 may comprise a matrix of vectors, where each vector represents a token in the sequence. The input embedding layer maps each token to a high-dimensional vector that captures the semantic meaning of the token.

Positional encoding 810 is a fixed, learned vector that represents a position of a word in the input sequence. It is added to the input embedding 808 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 808. The positional encoding is a vector that represents the position of each token in the sequence.

The encoder 802 includes multiple self-attention layers. The self-attention layers are responsible for determining the importance of each input token in generating the output. The self-attention layer allows the model to compute relationships between different parts of the input sequence 806. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 802 uses a multi-head attention layer 812. The multi-head attention layer 812 uses multiple self-attention layers operating in parallel on different parts of the input data, producing multiple representations. The multi-head attention layer 812 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 816.

The feed forward layer 816 comprises a series of fully connected layers and activation functions. The feed forward layer 816 transforms the output of the multi-head attention layer 812 into a suitable representation for the final output. The feed forward layer 816 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a ReLu. The output of the feed forward layer 816 is used as input to the next layer in the encoder 802.

The encoder 802 may also comprise a number of normalization layers, such as a normalization layer 814 and a normalization layer 818. The activations in each layer of the transformer architecture are normalized using layer normalization, which helps stabilize the training process and prevent the model from overfitting. A residual connection followed by layer normalization helps to stabilize the training process and make the model easier to train. The output of the normalization layer 818 is the final output from the encoder 802 and it is a vector representation of the input sequence 806. The final output from the normalization layer 818 is used as input to the multi-head attention layer 828 of the decoder 804.

The decoder 804 decodes the input sequence 806 to the original data format. Similar to the encoder 802, the decoder 804 shares the core elements of positional encoding, self-attention, and feedforward layers. As depicted in transformer model 800, the decoder 804 comprises a masked multi-head attention layer 824, a normalization layer 826, a multi-head attention layer 828, a normalization layer 830, a feed forward layer 832, and a normalization layer 834. The decoder 804 outputs a decoder output 844 to a linear layer 836. The linear layer 836 is a feedforward network that adapts the dimension of the input to the dimension of the output. The output of the linear layer 836 feeds into a softmax layer 838. The softmax layer 838 transforms the input into a vector of probabilities. The output of the softmax layer 838 is a set of an output probabilities 840 for the transformer model 800. The transformer model 800 then picks the word corresponding to the highest probability and uses it as a best output of the model.

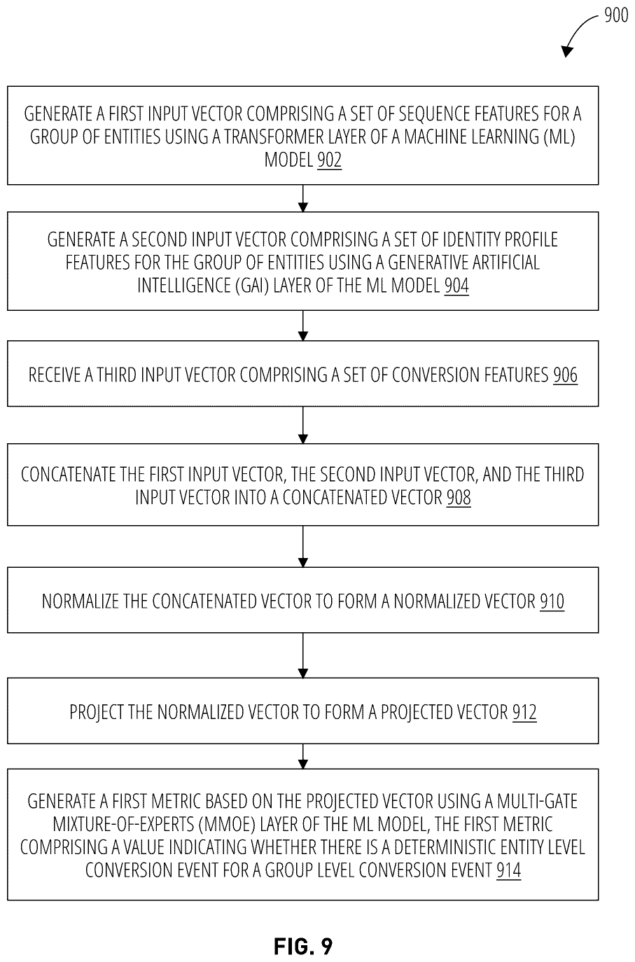

FIG. 9 illustrates an embodiment of a logic flow 900. The logic flow 900 may be representative of some or all of the operations executed by one or more embodiments described herein. For example, the logic flow 900 may include some or all of the operations performed by devices or entities within the connection network platform 112 of the connection network system 100, such as the server device 102 and/or the client device 104. More particularly, the logic flow 900 illustrates an example of operations for the connection network platform 112 of the connection network system 100, such as the content delivery application 120 for the content delivery system 300. For example, the logic flow 900 may be performed by the server device 102 and/or the client device 104 using a system 200, content delivery system 300, logic diagram 400, logic diagram 500, logic diagram 600, ML architecture 700, and/or transformer model 800.

As depicted in logic flow 900, at block 902, the logic flow 900 includes generating a first input vector comprising a set of sequence features for a group of entities using a transformer layer of a machine learning (ML) model. At 904, the logic flow 900 includes generating a second input vector comprising a set of identity profile features for the group of entities using a generative artificial intelligence (GAI) layer of the ML model. At block 906, the logic flow 900 includes receiving a third input vector comprising a set of conversion features. At block 908, the logic flow 900 includes concatenating the first input vector, the second input vector, and the third input vector into a concatenated vector. At block 910, the logic flow 900 includes normalizing the concatenated vector to form a normalized vector. At block 912, the logic flow 900 includes projecting the normalized vector to form a projected vector. At block 914, the logic flow 900 includes generating a first metric based on the projected vector using a multi-gate mixture-of-experts (MMOE) layer of the ML model, the first metric comprising a value indicating whether there is a deterministic entity level conversion event for a group level conversion event.

By way of example, an ML model 230 such as a sequential-based model 320 may use an ML architecture 700 for generating a first input vector 716 comprising a set of sequence features 702 for a group of entities using a transformer layer 704 of the sequential-based model 320. The ML architecture 700 may generate a second input vector 722 comprising a set of identity profile features 718 from identify profile text for the group of consuming entities 312 using a GAI layer 720 of the sequential-based model 320. The ML architecture 700 may receive a third input vector 726 comprising a set of conversion features 724. The ML architecture 700 may concatenate the first input vector 716, the second input vector 722, and the third input vector 726 into a concatenated vector 734. The ML architecture 700 may normalize the concatenated vector 734 to form a normalized vector 738. The ML architecture 700 may project the normalized vector 738 to form a projected vector 742. The ML architecture 700 may generate a first metric 772 based on the projected vector 742 using an MMOE layer 744 and a first classification sub-layer 760 of the sequential-based model 320. The first metric 772 may comprise a value indicating whether there is a deterministic entity level conversion event for a group level conversion event.

In some embodiments, for example, the ML architecture 700 may generate the first metric 772 using a classification layer 758, such as classification sub-layer 760, and a first gate 766 of a gating network 764. The first metric 772 may comprise an inflation value or a deflation value associated with a first objective, such as maximizing quality leads (QL) for a content delivery campaign 308.

In some embodiments, for example, the ML architecture 700 may generate a second metric 774 using the classification layer 758, such as classification sub-layer 762, and a second gate 768 of the gating network 764. The second metric 774 may comprise an inflation value or deflation value associated with a second objective, such as maximizing web conversions (WC) for a content delivery campaign 308.

In some embodiments, for example, the ML architecture 700 may implement the first gate 766 or the second gate 768 as a sparse gate or a dense gate.

In some embodiments, for example, the group of entities may include a label indicating an actual identity for the group of entities or a probabilistic identity for the group of entities.

In some embodiments, for example, the set of sequence features 702 may comprise a feature length multiplied by a defined number of time steps 614, wherein a time step 614 includes an engagement feature, token, or value.

In some embodiments, for example, the MMOE layer 744 of the sequential-based model 320 comprises an MMOE 746. The MMOE 746 may comprise a combination of a DCN and an MLP.

In some embodiments, for example, the GAI layer 720 may comprise a large language model (LLM), such as transformer model 800.

In some embodiments, for example, the ML architecture 700 may compress the first input vector 716 to reduce a sequence length to form a compressed vector. For example, a compression procedure may retain a first defined number of time steps 614 from the sequence length of the first input vector 716, pool a second defined number of time steps 614 from the sequence length of the first input vector 716, and generate the compressed vector with a sequence length of the first defined number of time steps 614 plus one.

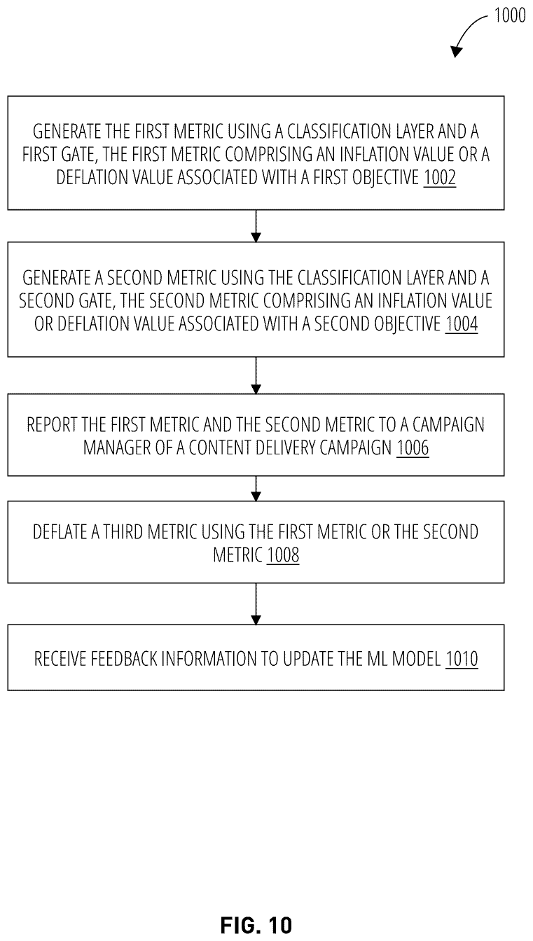

FIG. 10 illustrates an embodiment of a logic flow 1000. The logic flow 1000 may be representative of some or all of the operations executed by one or more embodiments described herein. For example, the logic flow 1000 may include some or all of the operations performed by devices or entities within the connection network platform 112 of the connection network system 100, such as the server device 102 and/or the client device 104. More particularly, the logic flow 1000 illustrates an example of operations for the connection network platform 112 of the connection network system 100, such as the content delivery application 120 for the content delivery system 300. For example, the logic flow 900 may be performed by the server device 102 and/or the client device 104 using a system 200, content delivery system 300, logic diagram 400, logic diagram 500, logic diagram 600, ML architecture 700, transformer model 800, and/or logic flow 900.

As depicted in logic flow 1000, at block 1002 the logic flow 1000 includes generating the first metric using a classification layer and a first gate, the first metric comprising an inflation value or a deflation value associated with a first objective. At block 1004, the logic flow 1000 includes generating a second metric using the classification layer and a second gate, the second metric comprising an inflation value or deflation value associated with a second objective. At block 1006, the logic flow 1000 includes reporting the first metric and the second metric to a campaign manager of a content delivery campaign. At block 1008, the logic flow 1000 includes deflating a third metric using the first metric or the second metric. At block 1010, the logic flow 1000 includes receiving feedback information to update the ML model.

In some embodiments, for example, the ML architecture 700 may generate the first metric 772 using a classification layer 758, such as classification sub-layer 760, and a first gate 766 of a gating network 764. The first metric 772 may comprise an inflation value or a deflation value associated with a first objective, such as maximizing quality leads (QL) for a content delivery campaign 308.

In some embodiments, for example, the ML architecture 700 may generate a second metric 774 using the classification layer 758, such as classification sub-layer 762, and a second gate 768 of the gating network 764. The second metric 774 may comprise an inflation value or deflation value associated with a second objective, such as maximizing web conversions (WC) for a content delivery campaign 308.

In some embodiments, for example, the ML architecture 700 may report the first metric 772 and the second metric 774 to a campaign manager 318 of a content delivery campaign 308. The campaign manager 318 may deflate a third metric using the first metric 772 or the second metric 774. For example, the third metric may represent member-attributed conversion events generated by the sequential-based model 320 using only privacy-safe cohort-based tracking data.

In some embodiments, for example, the campaign manager 318 may receive feedback information to update the sequential-based model 320. For example, the campaign manager 318 may receive feedback information from other components, systems, or ML models 230 of the content delivery system 300, based at least in part due to the first metric, second metric, and/or third metric.

FIG. 11 illustrates an apparatus 1100. The apparatus 1100 depicts a training device 1102 suitable for training an ML model 1120 for the connection network system 100, such as the ML models 230 and/or a GAI model of the GAI layer 720. Specifically, the training device 1102 trains the ML model 1120 to perform inferencing operations in support of the content delivery application 120 of the content delivery system 300.

As depicted in FIG. 11, the training device 1102 includes a processing circuitry 1104 and a memory unit 1106. The memory unit 1106 may store a set of ML components 1108 to support various AI/ML techniques. The ML components 1108 comprise a data collector 1110, a model trainer 1112, a model evaluator 1114 and a model inferencer 1116.

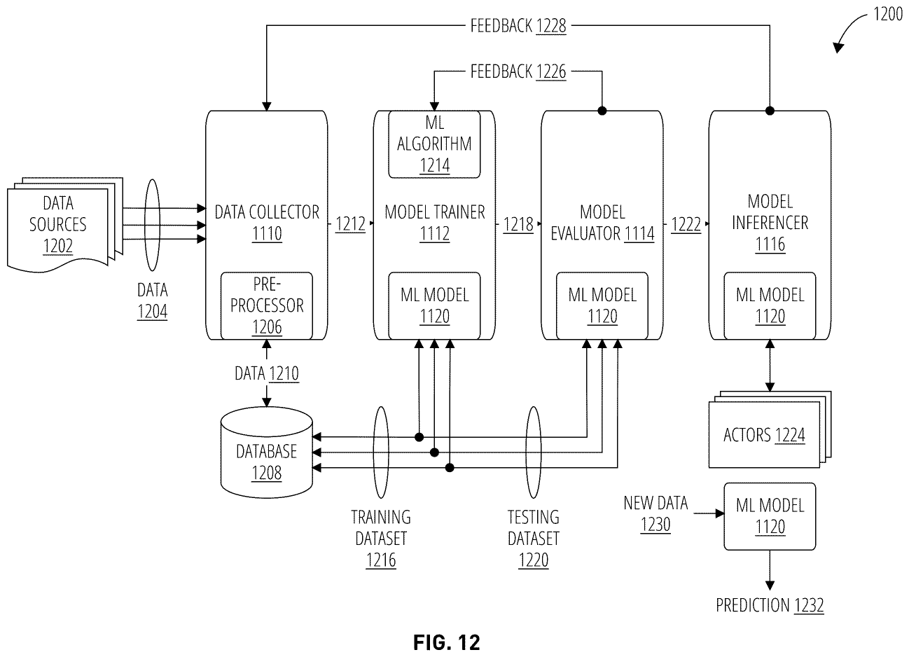

In general, the data collector 1110 collects data 1118 from one or more data sources to use as training data for an ML model 1120. The data collector 1110 collects different types of data 1118, such as text information, audio information, image information, video information, graphic information, and so forth. The model trainer 1112 receives as input the collected data and uses a portion of the collected data as test data for an AI/ML algorithm to train the ML model 1120. The model evaluator 1114 evaluates and improves the trained ML model 1120 using a portion of the collected data as test data to test the ML model 1120. The model evaluator 1114 also uses feedback information from the deployed ML model 1120. The model inferencer 1116 implements the trained ML model 1120 to receive as input new unseen data, generate one or more inferences on the new data, and output a result such as an alert, a recommendation or other post-solution activity. An exemplary AI/ML architecture for the ML components 1108 is described in more detail with reference to FIG. 12.

FIG. 12 illustrates a logic diagram 1200 suitable for use by the training device 1102 to generate the ML model 1120 for deployment by an inferencing device of the connection network platform 112. The logic diagram 1200 is an example of a system suitable for implementing various AI techniques and/or ML techniques to perform various training tasks on behalf of the various devices of the connection network system 100.

In one embodiment, the training device 1102 trains an ML model 1120. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss. To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 1102 may pretrain an ML model 1120 before training the ML model 1120 or trains a pretrained ML model 1120. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 1200 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1120, evaluate performance of the trained ML model 1120, and deploy the tested ML model 1120 as the trained ML model 1120 in a production environment, and continuously monitor and maintain it.

The ML model 1120 is a mathematical construct used to predict outcomes based on a set of input data. The ML model 1120 is trained using large volumes of training dataset 1216, and it can recognize patterns and trends in the training dataset 1216 to make accurate predictions. The ML model 1120 is derived from an ML algorithm 1214. A data set is fed into the ML algorithm 1214 which trains an ML model 1120 to “learn” a function that produces mappings between a set of inputs and a set of outputs with a reasonably high accuracy. Given a sufficiently large enough set of inputs and outputs, the ML algorithm 1214 finds the function for a given task. This function may even be able to produce the correct output for input that it has not seen during training. A data scientist prepares the mappings, selects and tunes the ML algorithm 1214, and evaluates the resulting model performance. Once the ML model 1120 is sufficiently accurate on test data, it can be deployed for production use.

The ML algorithm 1214 is generally a computational procedure used to identify patterns within data and make inferences or predictions without being explicitly programmed for every scenario. The ML algorithm 1214 can process input data, learn from it by adjusting internal parameters, and then apply the learned information to new, unseen data. The ML algorithm 1214 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1214 of the logic diagram 1200 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naïve Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 12, the logic diagram 1200 includes a set of data sources 1202 to source data 1204 for the training device 1102. Data sources 1202 may comprise any device capable generating, processing, storing or managing data 1204 suitable for a ML system. Examples of data sources 1202 include without limitation databases, web scraping, sensors and Internet of Things (IOT) devices, image and video cameras, audio devices, text generators, publicly available databases, private databases, and many other data sources 1202. The data sources 1202 may be remote from the training device 1102 and accessed via a network, local to the training device 1102 and accessed via a network interface, or may be a combination of local and remote data sources 1202.

The data sources 1202 source difference types of data 1204. By way of example and not limitation, the data 1204 includes structured data from relational databases, such as customer profiles, transaction histories, or product inventories. The data 1204 includes unstructured data from websites such as customer reviews, news articles, social media posts, or product specifications. The data 1204 includes data from temperature sensors, motion detectors, and smart home appliances. The data 1204 includes image data from medical images, security footage, or satellite images. The data 1204 includes audio data from speech recognition, music recognition, or call centers. The data 1204 includes text data from emails, chat logs, customer feedback, news articles or social media posts. The data 1204 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1204 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1202 are communicatively coupled to a data collector 1110. The data collector 1110 gathers relevant data 1204 from the data sources 1202. Once collected, the data collector 1110 may use a pre-processor 1206 to make the data 1204 suitable for analysis. This involves data cleaning, transformation, and feature engineering. Data preprocessing is a critical step in ML as it directly impacts the accuracy and effectiveness of the ML model 1120. The pre-processor 1206 receives the data 1204 as input, processes the data 1204, and outputs pre-processed data 1210 for storage in a database 1208. Examples for the database 1208 includes a hard drive, solid state storage, and/or random access memory (RAM).

The data collector 1110 is communicatively coupled to a model trainer 1112. The model trainer 1112 performs AI/ML model training, validation, and testing which may generate model performance metrics as part of the model testing procedure. The model trainer 1112 receives the pre-processed data 1210 as input 1212 or via the database 1208. The model trainer 1112 implements a suitable ML algorithm 1214 to train an ML model 230 on a set of training dataset 1216 from the pre-processed data 1210. The training process involves feeding the pre-processed data 1210 into the ML algorithm 1214 to produce or optimize an ML model 1120. The training process adjusts its parameters until it achieves an initial level of satisfactory performance.

The model trainer 1112 is communicatively coupled to a model evaluator 1114. After an ML model 1120 is trained, the ML model 1120 needs to be evaluated to assess its performance. This is done using various metrics such as accuracy, precision, recall, and F1 score. The model trainer 1112 outputs the ML model 1120, which is received as input 1212 or from the database 1208. The model evaluator 1114 receives the ML model 230 as input 1218, and it initiates an evaluation process to measure performance of the ML model 1120. The evaluation process includes providing feedback 1226 to the model trainer 1112. The model trainer 1112 re-trains the ML model 1120 to improve performance in an iterative manner.

The model evaluator 1114 is communicatively coupled to a model inferencer 1116. The model inferencer 1116 provides AI/ML model inference output (e.g., inferences, predictions or decisions). Once the ML model 1120 is trained and evaluated, it is deployed in a production environment where it is used to make predictions on new data. The model inferencer 1116 receives the evaluated ML model 1120 as input 1222. The model inferencer 1116 uses the evaluated ML model 1120 to produce insights or predictions on real data, which is deployed as a final production ML model 1120. The inference output of the ML model 1120 is use case specific. The model inferencer 1116 also performs model monitoring and maintenance, which involves continuously monitoring performance of the ML model 1120 in the production environment and making any necessary updates or modifications to maintain its accuracy and effectiveness. The model inferencer 1116 provides feedback 1226 to the data collector 1110 to train or re-train the ML model 1120. The feedback 1226 includes model performance feedback information, which is used for monitoring and improving performance of the ML model 1120.

Some or all of the model inferencer 1116 is implemented by various actors 1224 in the logic diagram 1200, including the ML model 1120 of the connection network platform 112, for example. The actors 1224 use the deployed ML model 1120 on new data to make inferences or predictions for a given task, and output a prediction 1232. The actors 1224 implement the model inferencer 1116 locally, or remotely receives outputs from the model inferencer 1116 in a distributed computing manner. The actors 1224 trigger actions directed to other entities or to itself. The actors 1224 provide feedback 1228 to the data collector 1110 via the model inferencer 1116. The feedback 1228 comprise data needed to derive training data, inference data or to monitor the performance of the ML model 1120 and its impact to the network through updating of key performance indicators (KPIs) and performance counters.

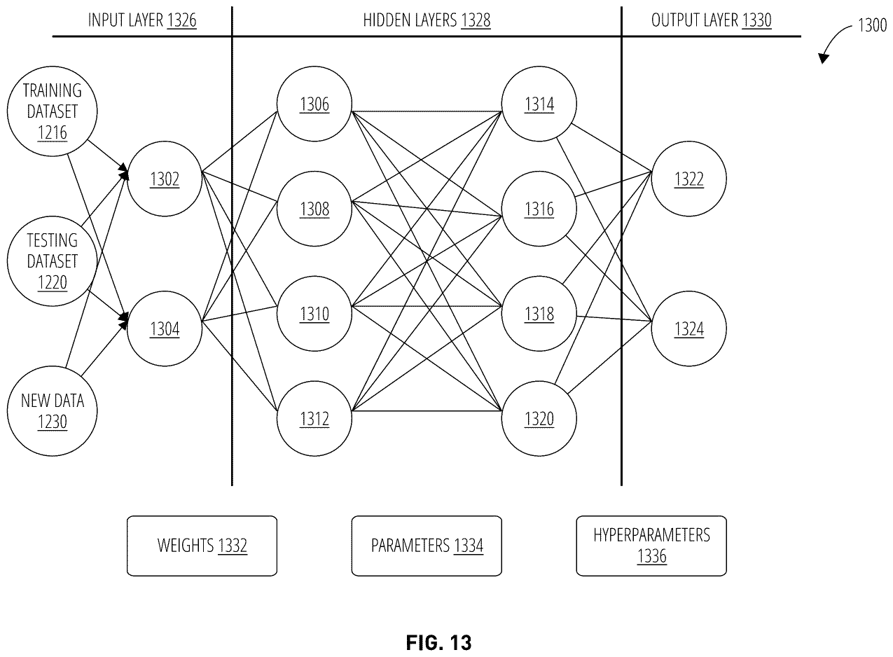

As previously described with reference to FIGS. 1, 2, the connection network system 100 and/or the apparatus 1100 may implement some or all of the logic diagram 1200 to support various use cases and solutions for various AI/ML tasks. In various embodiments, the training device 1102 of the apparatus 1100 uses the logic diagram 1200 to generate and train the ML model 230 for use by the connection network platform 112 for the client application 110. In one embodiment, for example, the training device 1102 may train the ML model 1120 as a neural network, as described in more detail with reference to FIG. 13. Other use cases and solutions for AI/ML are possible as well, and embodiments are not limited in this context.

FIG. 13 illustrates an embodiment of an artificial neural network 1300. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1300 comprises multiple node layers, containing an input layer 1326, one or more hidden layers 1328, and an output layer 1330. Each layer comprises one or more nodes, such as nodes 1302 to 1324. As depicted in FIG. 13, for example, the input layer 1326 has nodes 1302, 1304. The artificial neural network 1300 has two hidden layers 1328, with a first hidden layer having nodes 1306, 1308, 1310 and 1312, and a second hidden layer having nodes 1314, 1316, 1318 and 1320. The artificial neural network 1300 has an output layer 1330 with nodes 1322, 1324. Each node 1302 to 1324 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1300 relies on training dataset 1216 to learn and improve accuracy over time. However, once the artificial neural network 1300 is fine-tuned for accuracy, and tested on testing dataset 1220, the artificial neural network 1300 is ready to classify and cluster new data 1230 at a high velocity. Tasks in speech recognition or image recognition can take minutes versus hours when compared to the manual identification by human experts.

Once an input layer 1326 is determined, a set of weights 1332 are assigned. The weights 1332 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1300 as a feedforward network.

In one embodiment, the artificial neural network 1300 leverages sigmoid neurons, which are distinguished by having values between 0 and 1. Since the artificial neural network 1300 behaves similarly to a decision tree, cascading data from one node to another, having x values between 0 and 1 will reduce the impact of any given change of a single variable on the output of any given node, and subsequently, the output of the artificial neural network 1300.

The artificial neural network 1300 has many practical use cases, like image recognition, speech recognition, text recognition or classification. The artificial neural network 1300 leverages supervised learning, or labeled datasets, to train the algorithm. As the model is trained, its accuracy is measured using a cost (or loss) function. This is also commonly referred to as the mean squared error (MSE). An example of a cost function is shown in Equation (7), as follows:

$$Cost Function = MSE = \frac{1}{2 m} {\sum }_{i = 1}^{m} {( {\hat{y}}_{i} - {y}_{i} )}^{2} \to MIN \qquad EQUATION ( 7 )$$

In Equation (3), i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1334 of the model adjust to gradually converge at the minimum.

In one embodiment, the artificial neural network 1300 is feedforward, meaning it flows in one direction only, from input to output. In one embodiment, the artificial neural network 1300 uses backpropagation. Backpropagation is when the artificial neural network 1300 moves in the opposite direction from output to input. Backpropagation allows calculation and attribution of errors associated with each neuron 1302 to 1324, thereby allowing adjustment to fit the parameters 1334 of the ML model 230 appropriately.

The artificial neural network 1300 is implemented as different neural networks depending on a given task. Neural networks are classified into different types, which are used for different purposes. In one embodiment, the artificial neural network 1300 is implemented as a feedforward neural network, or multi-layer perceptrons (MLPs), comprised of an input layer 1326, hidden layers 1328, and an output layer 1330. While these neural networks are also commonly referred to as MLPs, they are actually comprised of sigmoid neurons, not perceptrons, as most real-world problems are nonlinear. Trained data 1204 usually is fed into these models to train them, and they are the foundation for computer vision, natural language processing, and other neural networks. In one embodiment, the artificial neural network 1300 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1300 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1300 is implemented as any type of neural network suitable for a given operational task of system 200, and the MLP, CNN, and RNN are merely a few examples. Embodiments are not limited in this context.

The artificial neural network 1300 includes a set of associated parameters 1334. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1300 is implemented as a deep learning neural network. The term deep learning neural network refers to a depth of layers in a given neural network. A neural network that has more than three layers-which would be inclusive of the inputs and the output—can be considered a deep learning algorithm. A neural network that only has two or three layers, however, may be referred to as a basic neural network. A deep learning neural network may tune and optimize one or more hyperparameters 1336. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

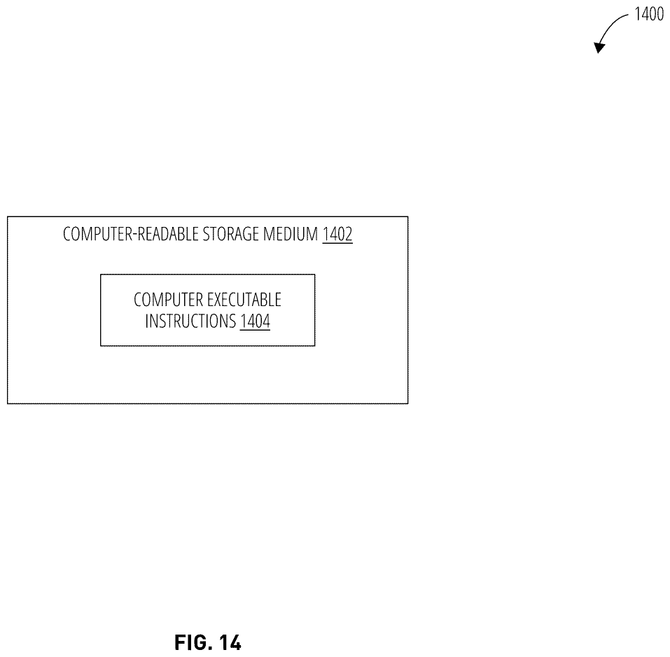

FIG. 14 illustrates an apparatus 1400. Apparatus 1400 comprises any non-transitory computer-readable storage medium 1402 or machine-readable storage medium, such as an optical, magnetic or semiconductor storage medium. In various embodiments, apparatus 1400 comprises an article of manufacture or a product. In some embodiments, the computer-readable storage medium 1402 stores computer executable instructions with which one or more processing devices or processing circuitry can execute. For example, computer executable instructions 1404 includes instructions to implement operations described with respect to any logic flows described herein. Examples of computer-readable storage medium 1402 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1404 include any suitable type of code, such as source code, compiled code, interpreted code, executable code, static code, dynamic code, object-oriented code, visual code, and the like.

FIG. 15 illustrates an embodiment of a computing architecture 1500. Computing architecture 1500 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1500 has a single processor with one core or more than one processor. Note that the term “processor” refers to a processor with a single core or a processor package with multiple processor cores. In at least one embodiment, the computing architecture 1500 is representative of the components of the system 200. More generally, the computing architecture 1500 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1500. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 15, computing architecture 1500 comprises a system-on-chip (SoC) 1502 for mounting platform components. System-on-chip (SoC) 1502 is a point-to-point (P2P) interconnect platform that includes a first processor 1504 and a second processor 1506 coupled via a point-to-point interconnect 1570 such as an Ultra Path Interconnect (UPI). In other embodiments, the computing architecture 1500 is another bus architecture, such as a multi-drop bus. Furthermore, each of processor 1504 and processor 1506 are processor packages with multiple processor cores including core(s) 1508 and core(s) 1510, respectively. While the computing architecture 1500 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1504 and chipset 1532. Some platforms include additional components and some platforms include sockets to mount the processors and/or the chipset. Furthermore, some platforms do not have sockets (e.g. SoC, or the like). Although depicted as a SoC 1502, one or more of the components of the SoC 1502 are included in a single die package, a multi-chip module (MCM), a multi-die package, a chiplet, a bridge, and/or an interposer. Therefore, embodiments are not limited to a SoC.

The processor 1504 and processor 1506 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1504 and/or processor 1506. Additionally, the processor 1504 need not be identical to processor 1506.

Processor 1504 includes an integrated memory controller (IMC) 1520 and point-to-point (P2P) interface 1524 and P2P interface 1528. Similarly, the processor 1506 includes an IMC 1522 as well as P2P interface 1526 and P2P interface 1530. IMC 1520 and IMC 1522 couple the processor 1504 and processor 1506, respectively, to respective memories (e.g., memory 1516 and memory 1518). Memory 1516 and memory 1518 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1516 and the memory 1518 locally attach to the respective processors (i.e., processor 1504 and processor 1506). In other embodiments, the main memory couple with the processors via a bus and shared memory hub. Processor 1504 includes registers 1512 and processor 1506 includes registers 1514.

Computing architecture 1500 includes chipset 1532 coupled to processor 1504 and processor 1506. Furthermore, chipset 1532 are coupled to storage device 1550, for example, via an interface (I/F) 1538. The I/F 1538 may be, for example, a Peripheral Component Interconnect-enhanced (PCIe) interface, a Compute Express Link® (CXL) interface, or a Universal Chiplet Interconnect Express (UCIe) interface. Storage device 1550 stores instructions executable by circuitry of computing architecture 1500 (e.g., processor 1504, processor 1506, GPU 1548, accelerator 1554, vision processing unit 1556, or the like). For example, storage device 1550 can store instructions for the client device 202, the client device 206, the inferencing device 204, the training device 1102, or the like.

Processor 1504 couples to the chipset 1532 via P2P interface 1528 and P2P 1534 while processor 1506 couples to the chipset 1532 via P2P interface 1530 and P2P 1536. Direct media interface (DMI) 1576 and DMI 1578 couple the P2P interface 1528 and the P2P 1534 and the P2P interface 1530 and P2P 1536, respectively. DMI 1576 and DMI 1578 is a high-speed interconnect that facilitates, e.g., eight Giga Transfers per second (GT/s) such as DMI 3.0. In other embodiments, the processor 1504 and processor 1506 interconnect via a bus.

The chipset 1532 comprises a controller hub such as a platform controller hub (PCH). The chipset 1532 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1532 comprises more than one controller hub such as a chipset with a memory controller hub, a graphics controller hub, and an input/output (I/O) controller hub.

In the depicted example, chipset 1532 couples with a trusted platform module (TPM) 1544 and UEFI, BIOS, FLASH circuitry 1546 via I/F 1542. The TPM 1544 is a dedicated microcontroller designed to secure hardware by integrating cryptographic keys into devices. The UEFI, BIOS, FLASH circuitry 1546 may provide pre-boot code. The I/F 1542 may also be coupled to a network interface circuit (NIC) 1580 for connections off-chip.

Furthermore, chipset 1532 includes the I/F 1538 to couple chipset 1532 with a high-performance graphics engine, such as, graphics processing circuitry or a graphics processing unit (GPU) 1548. In other embodiments, the computing architecture 1500 includes a flexible display interface (FDI) (not shown) between the processor 1504 and/or the processor 1506 and the chipset 1532. The FDI interconnects a graphics processor core in one or more of processor 1504 and/or processor 1506 with the chipset 1532.

The computing architecture 1500 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11× (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1554 and/or vision processing unit 1556 are coupled to chipset 1532 via I/F 1538. The accelerator 1554 is representative of any type of accelerator device (e.g., a data streaming accelerator, cryptographic accelerator, cryptographic co-processor, an offload engine, etc.). One example of an accelerator 1554 is the Intel® Data Streaming Accelerator (DSA). The accelerator 1554 is a device including circuitry to accelerate copy operations, data encryption, hash value computation, data comparison operations (including comparison of data in memory 1516 and/or memory 1518), and/or data compression. Examples for the accelerator 1554 include a USB device, PCI device, PCIe device, CXL device, UCIe device, and/or an SPI device. The accelerator 1554 also includes circuitry arranged to execute machine learning (ML) related operations (e.g., training, inference, etc.) for ML models. Generally, the accelerator 1554 is specially designed to perform computationally intensive operations, such as hash value computations, comparison operations, cryptographic operations, and/or compression operations, in a manner that is more efficient than when performed by the processor 1504 or processor 1506. Because the load of the computing architecture 1500 includes hash value computations, comparison operations, cryptographic operations, and/or compression operations, the accelerator 1554 greatly increases performance of the computing architecture 1500 for these operations.

The accelerator 1554 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1554. For example, the accelerator 1554 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1554 via a non-posted write (e.g., a deferred memory write (DMWr)). One example of an instruction that atomically submits a work descriptor to the shared work queue of the accelerator 1554 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1554. The dedicated work queue may accept job submissions via commands such as the movdir64b instruction.

Various I/O devices 1560 and display 1552 couple to the bus 1572, along with a bus bridge 1558 which couples the bus 1572 to a second bus 1574 and an I/F 1540 that connects the bus 1572 with the chipset 1532. In one embodiment, the second bus 1574 is a low pin count (LPC) bus. Various input/output (I/O) devices couple to the second bus 1574 including, for example, a keyboard 1562, a mouse 1564 and communication devices 1566.

Furthermore, an audio I/O 1568 couples to second bus 1574. Many of the I/O devices 1560 and communication devices 1566 reside on the system-on-chip (SoC) 1502 while the keyboard 1562 and the mouse 1564 are add-on peripherals. In other embodiments, some or all the I/O devices 1560 and communication devices 1566 are add-on peripherals and do not reside on the system-on-chip (SoC) 1502.

FIG. 16 illustrates a block diagram of an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600.

As shown in FIG. 16, the communications architecture 1600 includes one or more clients 1602 and servers 1604. The clients 1602 and the servers 1604 are operatively connected to one or more respective client data stores 1608 and server data stores 1610 that can be employed to store information local to the respective clients 1602 and servers 1604, such as cookies and/or associated contextual information.

The clients 1602 and the servers 1604 communicate information between each other using a communication framework 1606. The communication framework 1606 implements any well-known communications techniques and protocols. The communication framework 1606 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1606 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1602 and the servers 1604. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

What is claimed is:

1. A method, comprising:
generating a first input vector comprising a set of sequence features for a group of entities using a transformer layer of a machine learning (ML) model;
compressing the first input vector to reduce a sequence length;
generating a second input vector comprising a set of identity profile features for the group of entities using a generative artificial intelligence (GAI) layer of the ML model;
receiving a third input vector comprising a set of conversion features;
concatenating the first input vector, the second input vector, and the third input vector into a concatenated vector;
normalizing the concatenated vector to form a normalized vector;
projecting the normalized vector to form a projected vector; and
generating a first metric based on the projected vector using a multi-gate mixture-of-experts (MMOE) layer of the ML model, the first metric comprising a value indicating whether there is a deterministic entity level conversion event for a group level conversion event.

2. The method of claim 1, comprising generating the first metric using a classification layer and a first gate, the first metric comprising an inflation value or a deflation value associated with a first objective.

3. The method of claim 2, comprising generating a second metric using the classification layer and a second gate, the second metric comprising an inflation value or deflation value associated with a second objective.

4. The method of claim 3, wherein the first gate or the second gate comprises a sparse gate or a dense gate.

5. The method of claim 1, wherein the group of entities includes a label indicating an actual identity for the group of entities or a probabilistic identity for the group of entities.

6. The method of claim 1, wherein the set of sequence features comprise a feature length multiplied by a defined number of time steps, wherein a time step includes an engagement value.

7. The method of claim 1, wherein the MMOE layer of the ML model comprises a MMOE, the MMOE comprising a combination of a deep and cross network (DCN) and a multilayer perceptron (MLP).

8. The method of claim 1, wherein the transformer layer comprises a generative artificial intelligence (GAI) layer comprising a large language model (LLM).

9. The method of claim 1, wherein the ML model is a sequential-based model trained to perform sequential-based prediction at an event level.

10. The method of claim 1, comprising:
retaining a first defined number of steps from the sequence length of the first input vector;
pooling a second defined number of steps from the sequence length of the first input vector; and
generating the first input vector as a compressed vector with a sequence length of the first defined number of steps plus one.

11. A computing apparatus, comprising:
circuitry; and
a memory storing instructions that, when executed by the circuitry, causes the circuitry to:
generate a first input vector comprising a set of sequence features for a group of entities using a transformer layer of a machine learning (ML) model;
compress the first input vector to reduce a sequence length;
generate a second input vector comprising a set of identity profile features for the group of entities using a generative artificial intelligence (GAI) layer of the ML model;
receive a third input vector comprising a set of conversion features;
concatenate the first input vector, the second input vector, and the third input vector into a concatenated vector;
normalize the concatenated vector to form a normalized vector;
project the normalized vector to form a projected vector; and
generate a first metric based on the projected vector using a multi-gate mixture-of-experts (MMOE) layer of the ML model, the first metric comprising a value indicating whether there is a deterministic entity level conversion event for a group level conversion event.

12. The computing apparatus of claim 11, the circuitry to generate the first metric using a classification layer and a first gate, the first metric comprising an inflation value or a deflation value associated with a first objective.

13. The computing apparatus of claim 12, the circuitry to generate a second metric using the classification layer and a second gate, the second metric comprising an inflation value or deflation value associated with a second objective.

14. The computing apparatus of claim 13, wherein the first gate or the second gate comprises a sparse gate or a dense gate.

15. The computing apparatus of claim 11, wherein the MMOE layer of the ML model comprises a MMOE, the MMOE comprising a combination of a deep and cross network (DCN) and a multilayer perceptron (MLP).

16. The computing apparatus of claim 11, wherein the transformer layer comprises a generative artificial intelligence (GAI) layer comprising a large language model (LLM).

17. The computing apparatus of claim 11, wherein the ML model is a sequential-based model trained to perform sequential-based prediction at an event level.

18. The computing apparatus of claim 11, the circuitry to:
retain a first defined number of steps from the sequence length of the first input vector;
pool a second defined number of steps from the sequence length of the first input vector; and
generate the first input vector as a compressed vector with a sequence length of the first defined number of steps plus one.

19. A non-transitory computer-readable storage medium, the computer-readable storage medium including instructions that when executed by circuitry, cause the circuitry to:
generate a first input vector comprising a set of sequence features for a group of entities using a transformer layer of a machine learning (ML) model;
compress the first input vector to reduce a sequence length;
generate a second input vector comprising a set of identity profile features for the group of entities using a generative artificial intelligence (GAI) layer of the ML model;
receive a third input vector comprising a set of conversion features;
concatenate the first input vector, the second input vector, and the third input vector into a concatenated vector;
normalize the concatenated vector to form a normalized vector;
project the normalized vector to form a projected vector; and
generate a first metric based on the projected vector using a multi-gate mixture-of-experts (MMOE) layer of the ML model, the first metric comprising a value indicating whether there is a deterministic entity level conversion event for a group level conversion event.

20. The computer-readable storage medium of claim 19, comprising instructions that when executed by circuitry, cause the circuitry to:
generate the first metric using a classification layer and a first gate, the first metric comprising an inflation value or a deflation value associated with a first objective; and
generate a second metric using the classification layer and a second gate, the second metric comprising an inflation value or deflation value associated with a second objective.
